(19) United States
(12) Patent Application Publication
(10) Pub. No.: US 2026/0230884 A1
(43) Pub. Date: Aug. 6, 2026

(54) BEAM REPORTING BASED ON USER EQUIPMENT GROUPING

(71) Applicant: Google LLC, Mountain View, CA (US)

(72) Inventors: YUSHU ZHANG, Beijing (CN); Johg-Kae FWU, Sunnyvale, CA (US)

(21) Appl. No.: 19/150,886

(22) PCT Filed: Feb. 17, 2023
(86) PCT No.: PCT/CN2023/076865

§ 371 Date: Jul. 24, 2025

(51) Int. Cl. H04W 24/10

(52) U.S. Cl. CPC H04W 24/10

(57) ABSTRACT

Systems, devices, apparatus, and methods, including computer programs encoded on storage media, are described herein for beam reporting based on UE grouping. A first UE (102a) receives (312, 612, 912), a beam quality report of a second UE (102b) and detects (314, 914) whether a first beam quality based on beam measurements at the first UE (102a) and a second beam quality at the second UE (102b), according to the beam quality report, satisfy a grouping criterion. Based on the detecting (314, 914), the first UE (102a) sends, to a network entity (104), an indication (310a/610a, 316/916) that the first UE (102a) and the second UE (102b) belong to a UE group that provides (320) a single beam report for UEs in the UE group to the network entity (104).

### TECHNICAL FIELD

The present disclosure relates generally to wireless communication, and more particularly, to beam reporting based on user equipment (UE) grouping.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a UE can measure beams from a base station to select/identify a strongest beam for communicating with the base station. However, when multiple UEs are independently performing beam measurement and reporting to the base station, signaling overhead and power consumption costs may be high.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity (NE), such as a base station or a unit of a base station, may communicate with a user equipment (UE) using a beam among beams that the NE can emit. The NE may indicate a set of channel measurement resources (CMRs) to the UE for the UE to measure the NE's beams to select/identify one or more best beams from UE's perspective to be used by the NE for communicating with the UE. The UE may select/identify the beam(s) based on a measured quality of the beams in the beam set. The UE transmits a beam report to the network entity, the beam report indicating the measured beam quality of the best beam(s) to be used for communicating with the UE.

Conventionally, each UE in communication with the network entity independently performs beam measurement and reporting to the network entity. The network entity then informs the UE about the beam the network entity is going to use for upcoming communications, for example, by transmitting a transmission configuration indicator (TCI). However, a plurality of UEs (e.g., UEs that have a same or similar trajectory and orientation, such as UEs located inside a same vehicle) may have a same best network beam. Therefore, the plurality of UEs may be formed into a UE group, the UEs in the UE group receiving communications from the NE via the same beam. In such cases, signaling overhead and power consumption for the UEs in the UE group can be reduced by having only one UE in the UE group performing the beam measurement and reporting.

Before the network entity can include UEs into the UE group, the NE or the UE(s) have to determine/indicate whether the UE measured beams satisfy criterion for the UEs to be joined into the UE group. The UEs may coordinate with each other to determine which UE will indicate to the network entity whether the UE measured beams satisfy the criterion for the UE group. The network entity determines, based on a beam report received from one of the UEs, whether the measured beam quality by the UEs satisfies the UE grouping criterion. If so, the network entity can group the UEs into the UE group, where one UE of the group can perform UE group-based beam reporting to the network entity for the whole UE group.

According to some aspects, a UE receive, a beam quality report of a second UE and detects whether a first beam quality based on beam measurements at the first UE and a second beam quality at the second UE, according to the beam quality report, satisfy a grouping criterion. Based on the detection, the UE sends, to a network entity, an indication that the first UE and the second UE belong to a UE group that provides a single beam report for UEs in the UE group to the network

According to some aspects, a network entity receives, from a UE, an indication that the UE satisfies a grouping criterion for being in a UE group that provides a single beam report for UEs in the UE group to the network entity. Responsive to the receiving of the indication, the network entity transmits control signaling that includes information to adjust the UE group.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2A-2C illustrate diagrams for UE group-based beam reporting.

FIGS. 3A-3B illustrate signaling diagrams for a UE group beam report based on network-assisted information.

FIG. 4 illustrates a flowchart of a method of wireless communication at a UE for UE grouping based on network-assisted information.

FIG. 5 illustrates a flowchart of a method of wireless communication at a network entity for UE grouping based on network-assisted information.

FIGS. 6A-6B illustrate signaling diagrams for a UE group beam report based on coordination among UEs using beam report information.

FIG. 7 illustrates a flowchart of a method of wireless communication at a UE for UE grouping based on UE coordination of beam report information.

FIG. 8 illustrates a flowchart of a method of wireless communication at a network entity for UE grouping based on UE coordination of beam report information.

FIGS. 9A-9B illustrate signaling diagrams for a UE group beam report based on coordination among UEs via beam measurements.

FIG. 10 illustrates a flowchart of a method of wireless communication at a UE for UE grouping based on UE coordination of beam measurements.

FIG. 11 illustrates a flowchart of a method of wireless communication at a network entity for UE grouping based on UE coordination of beam measurements.

FIG. 12 is a flowchart of a method of wireless communication at a UE for a UE group-based beam report.

FIG. 13 is a flowchart of a method of wireless communication at a network entity for a UE group-based beam report.

FIG. 14 is a diagram illustrating a hardware implementation for an example UE apparatus.

FIG. 15 is a diagram illustrating a hardware implementation for one or more example network entities.

### DETAILED DESCRIPTION

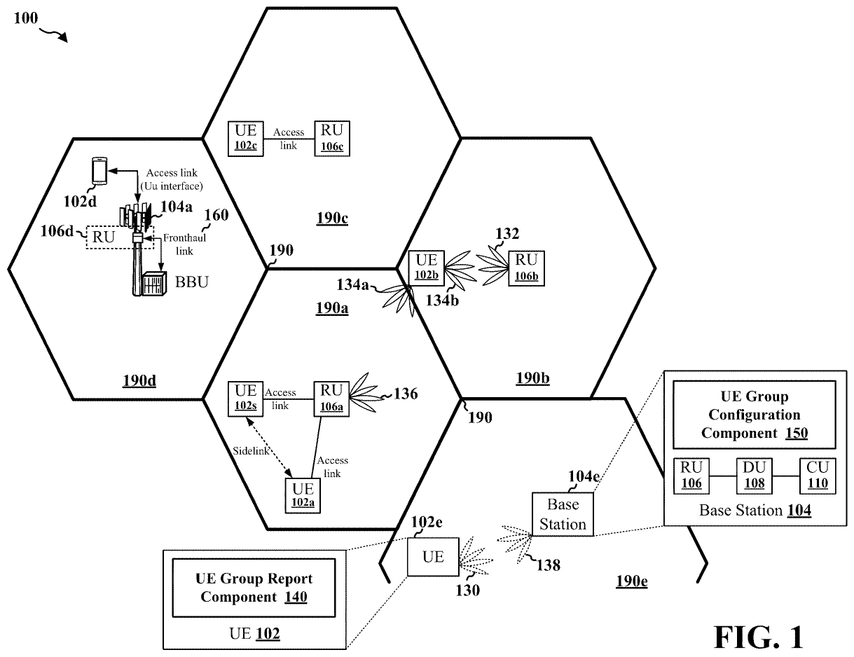

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a, 106b, 106c, 106d may communicate with the UEs 102a, 102b, 102c, 102d, and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106, such as the RU 106c of the cell 190c, may communicate with the UEs 102, such as the UE 102c, via an access link or via over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Still referring to FIG. 1, in certain aspects, any of the UEs 102 may include a UE group report component 140 configured to receive, a beam quality report of a second UE; detect whether a first beam quality based on beam measurements at the first UE and a second beam quality at the second UE, according to the beam quality report, satisfy a grouping criterion; and based on the detection, send to a network entity, an indication that the first UE and the second UE belong to a UE group that provides a single beam report for UEs in the UE group to the network entity.

In certain aspects, any of the base stations 104 or a network entity of the base stations 104 may include a UE group configuration component 150 configured to receive, from a UE, an indication that the UE satisfies a grouping criterion for being in a UE group that provides a single beam report for UEs in the UE group to the network entity; and responsive to the receiving of the indication, transmit control signaling that includes information to adjust the UE group.

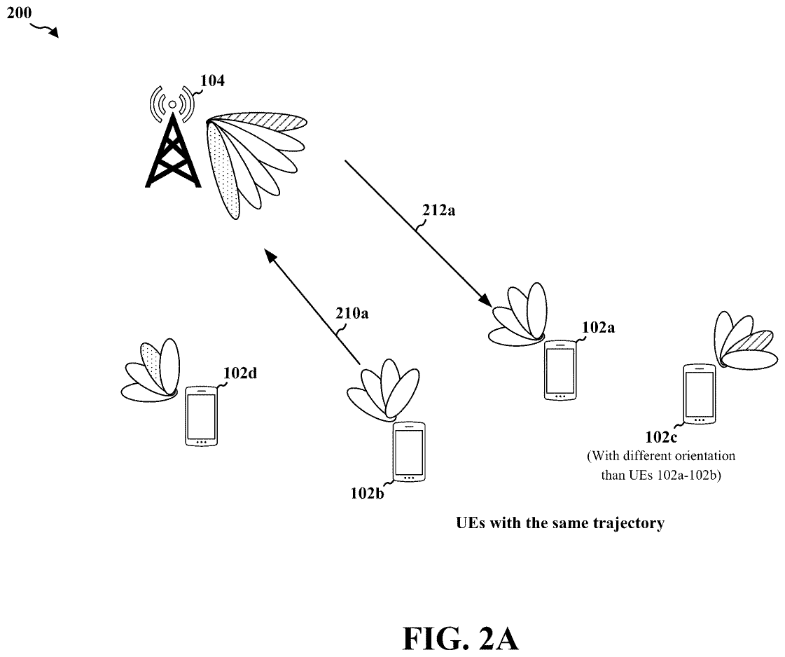

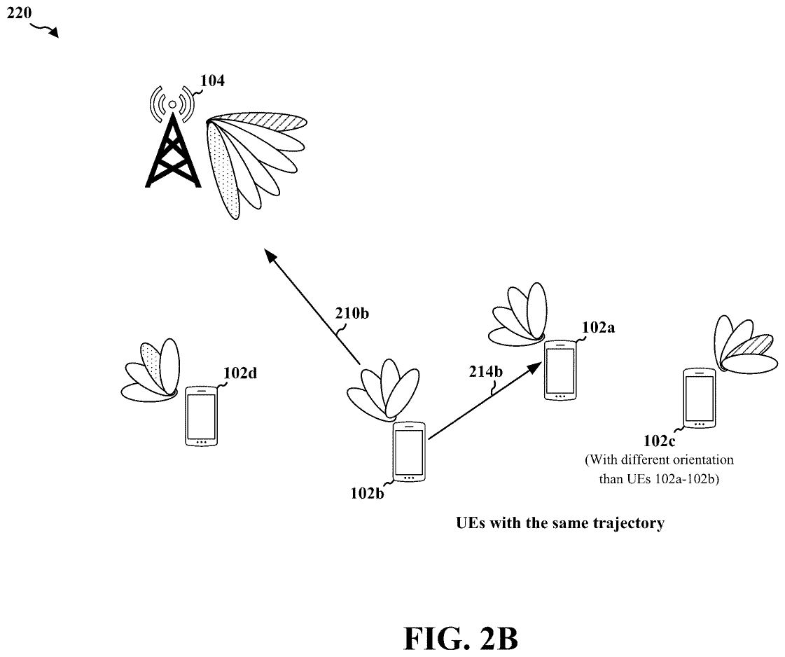

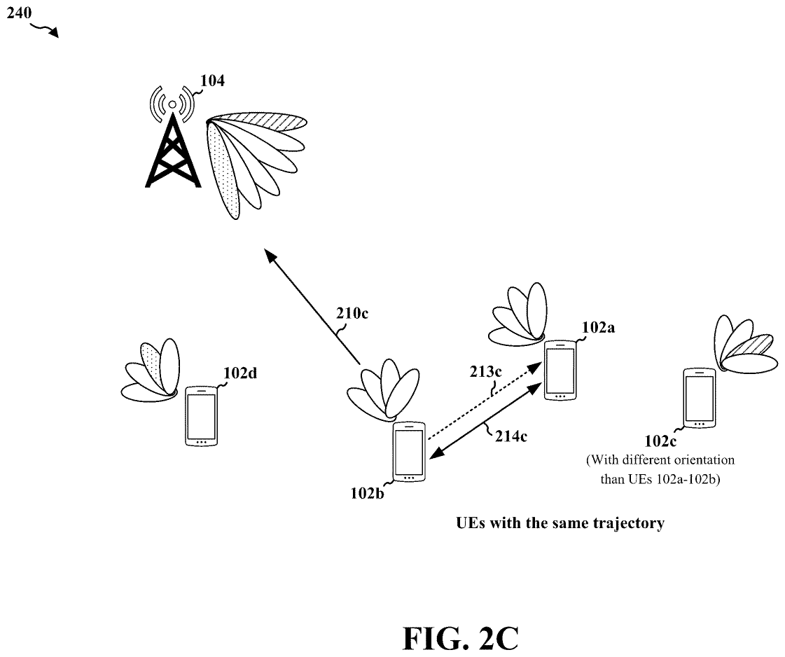

Accordingly, FIG. 1 describes a wireless communication system that may be implemented in connection with aspects of one or more other figures described herein, such as aspects illustrated in FIGS. 2A-2C. Further, although the following description may be focused on 5G NR, the concepts described herein may be applicable to other similar areas, such as 5G-Advanced and future versions, LTE, LTE-advanced (LTE-A), and other wireless technologies, such as 6G.

FIGS. 2A-2C illustrate diagrams 200-240 for UE group-based beam reporting. A cell radius/coverage area of a network entity 104, such as a base station, may be based on a link budget. The “link budget” refers to an accumulation of total gains and losses in a system, which provide a received signal level at a receiver, such as a UE 102. The receiver may compare the received signal level to a receiver sensitivity to determine whether a channel provides at least a minimum signal strength for signals communicated between the receiver and a transmitter (e.g., the UEs 102 and the network entity 104).

In order to increase the link budget, the network entity 104 and the UEs 102 may perform an analog beamforming operation to activate a beam pair having an increased signal strength. Both the network entity 104 and the UEs 102 maintain a plurality of beams that may be used for the beam pair. A beam pair that decreases a coupling loss may result in an increased coverage gain for the network entity 104 and the UEs 102. “Coupling loss” refers to a path loss/reduction in power density between a first antenna of a network entity 104 and a second antenna of a UE 102 and may be indicated in units of decibel (dB). Beam selection procedures for the beam pair activated by the network entity 104 and the UEs 102 may be associated with one or more of beam measurement operations, beam measurement reporting, or beam indication procedures.

Conventional beam reporting procedures have been UE-specific. That is, each UE 102 in communication with the network entity 104 performs an independent beam measurement and report procedure with the network entity 104. The network entity 104 may then select a beam for a UE 102 via transmission configuration indicator (TCI) update signaling. However, some UEs 102a, 102b, 102c may share a same or similar trajectory. For example, the UEs 102a, 102b, 102c may be inside a same vehicle and may be in close proximity to each other. Hence, a best (e.g., strongest) network beam for the UEs 102a, 102b, 102c could be the same, if the UEs 102a, 102b, 102c also have a same orientation. That is, as a result of directional antennas being included in the UEs 102, the best/strongest network beams may be different for the UEs 102a, 102b, 102c, even though the UEs 102a, 102b, 102c share the same or similar trajectory, when their orientations are different. For example, the UE 102a, 102b, 102c may be in a same car/vehicle and, thus, share the same trajectory. However, the UE 102c has a different orientation than the UEs 102a-102b. In further examples, another UE 102d is located outside the car/vehicle and, therefore, has a different trajectory than the UEs 102a-102c that are located within the car/vehicle.

The UEs 102a-102b that share both the same trajectory and orientation may utilize a common network beam for communicating with the network entity 104. Accordingly, the UEs 102a-102b do not have to perform independent beam measurement and reporting procedures with the network entity 104, as one of the UEs 102a-102b can perform beam measurement and reporting for both of the UEs 102a-102b, which may be regarded as a UE group. Independent beam measurements and reports by the UEs 102a-102b results in increased overhead and UE power consumption at a UE (e.g., the UE 102b) that could otherwise refrain from performing the measuring and reporting when included in a UE group with a group leader UE that performs the measuring and reporting for the whole UE group.

Before a UE 102 can measure and report a beam quality for an entire UE group, the UE 102 may have to determine whether other UEs of the UE group have, or are expected to have, a same or similar trajectory and orientation as the UE 102 that is performing the measuring and reporting to the network entity 104 or, more specifically, whether other UEs of the UE group have, or are expected to have, a same best/strongest network beam. Hence, a UE-group monitoring procedure may be implemented to determine whether the other UEs are part of a beam report group with the measuring/reporting UE.

In a first example, as illustrated in the diagram 200 of FIG. 2A, a beam report for a UE group is implemented based on network-assisted information. The network entity 104 receives 210a a beam report from the second UE 102b and relays 212a the beam report to the first UE 102a. The first UE 102a may be monitoring the UE group. Hence, the first UE 102a may determine whether the second UE 102b shares a common best network beam with the UEs of the UE group after receiving 212a the relayed beam report from the network entity 104.

In a second example, as illustrated in the diagram 220 of FIG. 2B, the beam report for the UE group is implemented based on coordination among the UEs 102a-102b using beam report information. The second UE 102b transmits 214b the beam report to the first UE 102a. In some implementations, the second UE 102b transmits 214b the beam report to the first UE 102a in a dedicated signal. In other implementations, the second UE 102b transmits the beam report in a signal that is also received 210b by the network entity 104, which could then provide relay support for the first UE 102a and/or confirm the UE grouping with additional information received from the first UE 102a. If the second UE 102b transmits 214b the beam report to the first UE 102a using dedicated signaling, the first UE 102a determines whether the second UE 102b shares a common best network beam with the UEs of the UE group.

In a third example, as illustrated in the diagram 240 of FIG. 2C, the beam report for the UE group is implemented based on coordination among the UEs 102a-102b via beam measurement. In some implementations, the second UE 102b transmits 213c a request to the first UE 102a for the first UE 102a to send 214c a measured beam quality report back to the second UE 102b, or the second UE 102b may receive 214c the measured beam quality report freely from the first UE 102a (e.g., without transmitting a request to the first UE 102a). The second UE 102b transmits 210c a beam report to the network entity 104 based on the measured beam quality report received 214c from the first UE 102a and a measured beam quality by the second UE 102b. In other implementations, the first UE 102a receives 214c an indicated beam quality report by the second UE 102b and, in response, transmits 214c a measured beam report of the first UE 102a back to the second UE 102b, which sends 210c the beam report for the UE group to the network entity 104. In both implementations, the beam report includes the coordinated beam measurement results of the first UE 102a and the second UE 102b.

The network entity 104 may semi-statically or dynamically configure/indicate one of the first UE 102a or the second UE 102b to transmit the beam report and the other UE to perform UE group detection. The network entity 104 may transmit radio resource control (RRC) signaling or a medium access control-control element (MAC-CE) for the semi-static configuration of a UE 102 within the UE group, or the network entity 104 may transmit downlink control information (DCI) for dynamic configuration of the UE 102 within the UE group. The UE group can include more than two UEs, in some examples.

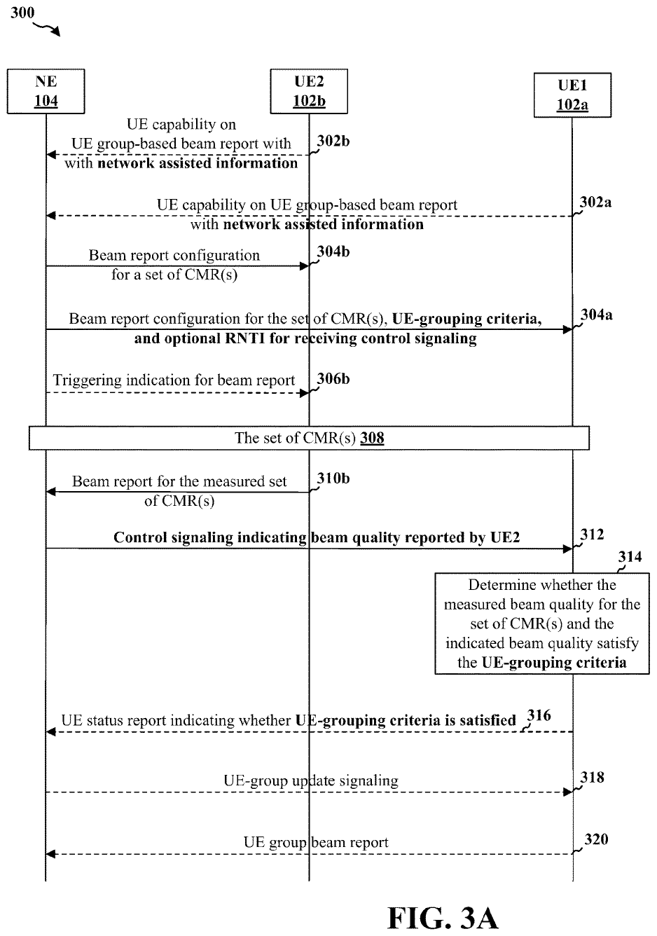

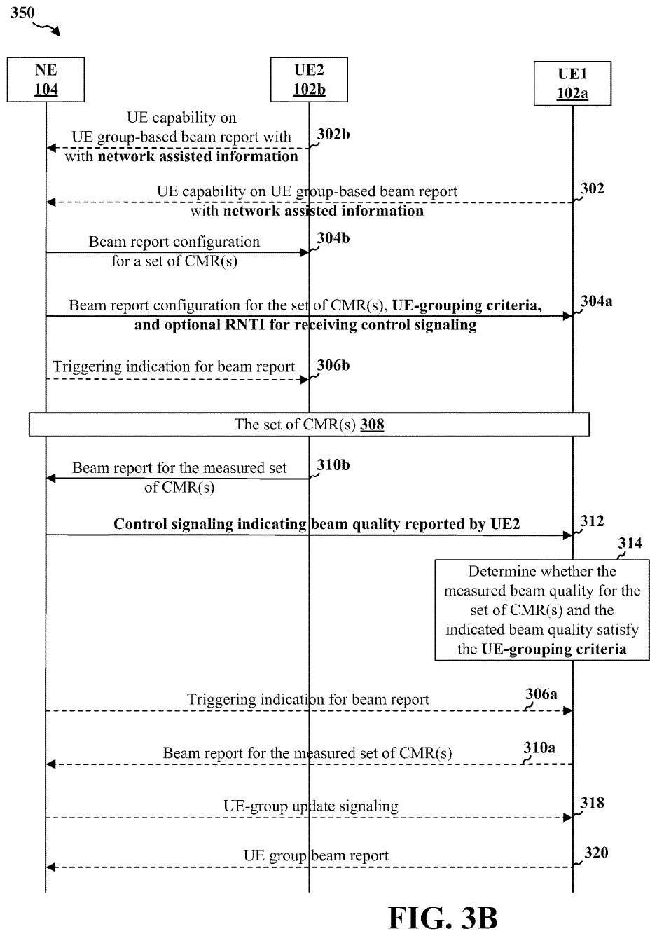

UE group-based beam reports may reduce signaling overhead and power consumption by the UEs 102. Transmitting a single UE group-based beam report for all the UEs in the UE group reduces the beam reporting overhead for the other UEs in the UE group, which may improve an overall system performance. The UEs of the UE group that do not send/transmit a beam report may experience a power savings as a result of power that would otherwise be consumed for independent beam measurement and reporting by the UEs 102. FIGS. 2A-2C illustrate example techniques for sending, to the network entity, a beam report for a group of UEs, whereas FIGS. 3A-3B, 6A-6B, and 9A-9B illustrate signaling procedures for grouping the UEs to perform the example techniques described with respect to FIGS. 2A, 2B, and 2C, respectively.

FIGS. 3A-3B illustrate signaling diagrams 300-350 for a UE group beam report based on network-assisted information. The first UE 102a may report 302, to the network entity 104, a UE capability for a UE group-based beam report based on network-assisted information. In other implementations, the network entity 104 may receive the UE capability from a core network (e.g., an Access and Mobility Management Function (AMF)) or from a second network entity. The UE capability may indicate whether the UE supports UE-group based beam reports and/or a maximum number of indicated beams for a network-assisted information procedure (e.g., four different control signals from the network entity 104).

The network entity 104 sends 304a-304b control signaling to the first UE 102a and the second UE 102b for a beam report configuration (e.g., channel state information (CSI)-ReportConfig) for a set of channel measurement resources (CMRs) 308. The control signaling transmitted 304a to the first UE 102a may include UE grouping criteria for a UE group that receives a same network beam from the network entity 104. In some implementations, a flag may be indicated in the control signaling to enable the UE group-based beam report. The UE grouping criteria may indicate a threshold for the first UE 102a to determine 314 whether both UEs 102a-102b satisfy the UE group-based beam report criteria. The threshold may be a layer 1 reference signal received power (L1-RSRP) threshold, a layer 1 signal-to-interference plus noise ratio (L1-SINR) threshold, an L1-RSRP offset threshold, or an L1-SINR offset threshold. The threshold may be predefined (e.g., the L1-RSRP threshold may be predefined as −120 dBm, the L1-SINR threshold may be predefined as 0 dB, and the L1-RSRP offset threshold and the L1-SINR offset threshold may be predefined as 9 dB). In some implementations, the network entity 104 may configure two thresholds, where a first threshold is for joining the UE group and a second threshold is for leaving the UE group.

The control signaling transmitted 304a to the first UE 102a may indicate a radio network temporary identifier (RNTI) for the first UE 102a to receive 312 the network-assisted information. If the network entity 104 does not configure the RNTI, the first UE 102a may receive the network-assisted information control signaling based on a cell-RNTI (C-RNTI). The network entity 104 may configure UEs in a same UE group with a same RNTI for providing groupcast-based network-assisted information. In examples, the network entity 104 transmits 304a-304b the configuration to the first UE 102a and the second UE 102b through RRC signaling. The RRC signaling may indicate an RRCReconfiguration message from network entity 104 to the UEs 102a-102b or a system information block (SIB), where the SIB may be a traditional type of SIB (e.g., SIB1) or a different SIB (e.g., SIB J, where J corresponds to an integer greater than 21) transmitted by the network entity 104. The RRC signaling may also include the CSI-ReportConfig. The RRC signaling may indicate the set of CMRs 308 for beam measurement and parameter(s) for the determination 314 of the UE grouping criteria.

The network entity 104 may transmit 306b a triggering indication to the second UE 102b for a beam report based on the set of CMRs 308. The triggering indication may be transmitted 306b through control signaling via MAC-CE or DCI. For example, the network entity 104 triggers 306b a semi-persistent beam report through the MAC-CE and triggers 306b an aperiodic beam report through the DCI. The second UE 102b transmit 310b the beam report to the network entity 104 based on the set of CMRs 308.

After receiving 310b the beam report from the second UE 102b, the network entity 104 transmits 312 additional control signaling to the first UE 102a indicating a beam quality reported by the second UE 102b for the set of CMRs 308. Based on the beam quality information relayed from the second UE 102b to the first UE 102a by the network entity 104, the first UE 102a determines 314 whether both UEs 102a-102b satisfy the UE-grouping criteria for a UE group-based beam report. That is, the first UE 102a determines 314 whether a measured beam quality by the first UE 102a for the set of CMRs 308 and an indicated beam quality of the second UE 102b for the set of CMRs 308 satisfy the UE grouping criteria.

The first UE 102a transmits 316, 310a a report to the network entity 104 based on the determination 314 of the UE grouping criteria. For example, in the diagram 300, the first UE 102a transmits 316 a UE status report indicating whether the UE grouping criteria is satisfied. In the diagram 350, the first UE 102a the first UE 102a sends 310a a beam report to the network entity 104 for the measured set of CMRs. The network entity 104 may transmit 306a a second triggering indication for the beam report from the first UE 102a and, in response to the triggering indication, the first UE 102a sends 310a the beam report to the network entity 104, such that the network entity 104 may determine whether the UE grouping criteria is satisfied. The configuration may include an indicator that enables the first UE 102a to determine whether to transmit 310a the beam report.

If the UE grouping criteria is not satisfied, the first UE 102a may not transmit the beam report to the network entity 104. That is, the first UE 102a may refrain from transmitting the beam report if the UE grouping criteria is not satisfied, regardless of whether the network entity 104 transmitted 306a the second triggering indication for the beam report. Otherwise, the first UE 102a may transmit 310a the beam report when triggered 306a by the network entity 104 if the UE grouping criteria is satisfied. In the diagram 300, the first UE 102a may similarly refrain from transmitting 316 the UE status report to the network entity 104, if the UE grouping criteria is not satisfied, and may transmit 316 the UE status report to the network entity 104 when the UE grouping criteria is satisfied.

The configuration transmitted 304a to the first UE 102a may include a first counter N1 for leaving the UE group and a second counter N2 for joining the UE group. If the number of consecutively detected negative UE grouping instances is greater than N1, the first UE 102a may determine to leave the UE group. If the number of consecutively detected positive UE grouping instances is greater than N2, the first UE 102a may determine to join the UE group. In some examples, parameters such as N1=1 and/or N2=2 can be predefined for the first UE 102a. If the network entity 104 determines based on (non-)reception 310a/316 of a report that the UE grouping criteria is not satisfied, or if the first UE 102a sends 310a/316 a report that indicates a negative status for UE grouping, the network entity 104 may transmit 318 UE group update signaling to the first UE 102a to update the UE group (e.g., joining or leaving of UEs to/from the UE group).

The network entity 104 may transmit 312 the network-assisted information control signaling via MAC-CE, which may correspond to a physical downlink shared channel (PDSCH) associate with a C-RNTI. The network entity 104 may relayed 312 the beam report from the second UE 102b to the first UE 102a with the CMR index(es) and/or the corresponding L1-RSRP/L1-SINR received 310b from the second UE 102b. In other implementations, the network entity 104 transmits 312 a subset of beams from the reported beams to the first UE 102a. For example, the network entity 104 transmits beams based on N received CMR index(es) and/or corresponding L1-RSRP/L1-SINR, where N may be predefined (e.g., N=1) or configured 304a-304b by the network entity 104 (e.g., through RRC signaling or MAC-CE). If the network entity 104 configures 304a a plurality of beam report configurations for the first UE 102a, the network entity 104 may further indicate a CMR set index or a beam report configuration identifier (ID), such as a CSI-ReportConfigId, through the MAC-CE. If the network entity 104 configures 304a a plurality of serving cells for the first UE 102a, the network entity 104 may indicate the serving cell index through the MAC-CE. If the network entity 104 configures 304a a plurality of bandwidth parts (BWPs) for the first UE 102a, the network entity 104 may indicate the BWP index through the MAC-CE.

The network-assisted information control signaling transmitted 312 to the first UE 102a via MAC-CE may correspond to a PDSCH associate with a RNTI. The RNTI may be indicated in the configuration for the first UE 102a or may be predefined. The network entity 104 may configure the RNTI for a UE group to support a groupcast MAC-CE based beam report indication. The network entity 104 may further configure resources for the PDSCH (e.g., time-domain and frequency-domain resources, a modulation and coding scheme (MCS), demodulation reference signal (DMRS) port(s), etc.). In other implementations, the network entity 104 may transmit DCI scheduling the PDSCH, where the network entity 104 transmits a physical downlink control channel (PDCCH) with the DCI based on the configured RNTI. The network entity 104 may transmit the PDCCH in a common search space (CSS) (e.g., a Type3-CSS). The network entity 104 may also transmit 312 the network-assisted information control signaling by DCI based on a PDCCH associated with a C-RNTI. In examples, the network entity 104 transmits the PDCCH in a CSS or a UE-specific search space (USS).

The first UE 102a may determine 314 whether the UE grouping criteria is satisfied based on a beam quality offset between the beam quality measured by the first UE 102a and an indicated beam quality (e.g., reported 310b by the second UE 102b and relayed by the network entity 104 to the first UE 102a) for one or more beams. The first UE 102a may determine 314 that the UE grouping criteria is satisfied if a maximum beam quality offset for the indicated beams is below a threshold (e.g., 9 dB). The first UE 102a may determine 314 that the UE grouping criteria is not satisfied if the maximum beam quality offset for the indicated beams is greater than or equal to the threshold (e.g., 9 dB). In other implementations, the first UE 102a may determine 314 that the UE grouping criteria is satisfied if a minimum beam quality offset, an average beam quality offset, a best beam, or a worst beam of the indicated beams is below the threshold, and that the UE grouping criteria is not satisfied if the minimum beam quality offset, the average beam quality offset, the best beam, or the worst beam of the indicated beams is greater than or equal to the threshold. A “best beam” refers to a beam with a highest indicated beam quality (e.g., a highest L1-RSRP or a highest L1-SINR). A “worst beam” refers to a beam with a lowest indicated beam quality (e.g., a lowest L1-RSRP or a lowest L1-SINR). The first UE 102a may calculate the average beam quality offset based on linear averaging techniques or dB domain averaging techniques. The first UE 102a may determine 314 whether the UE grouping criteria has changed from being satisfied to unsatisfied based on the first UE102a consecutively detecting more than N1 negative UE grouping instances. The first UE 102a may also determine 314 whether the UE grouping criteria has changed from being unsatisfied to satisfied based on the first UE102a consecutively detecting more than N2 positive

The first UE 102a may further determine 314 the UE grouping based on the beam quality measured by the first UE 102a for at least one beam that is also indicated 312 in the control signaling from the network entity 104. For example, the first UE 102a determines 314 that the UE grouping criteria is satisfied if a maximum measured beam quality of the indicated beams is greater than a threshold. The threshold may be configured 304a-304b by the network entity 104 or predefined (e.g., an L1-RSRP of −100 dBm or an L1-SINR of 0 dB). The first UE 102a may determine 314 that the UE grouping criteria is not satisfied if the maximum measured beam quality for the indicated beams is less than or equal to the threshold. In other implementations, the first UE 102a determines 314 that the UE grouping criteria is satisfied if a minimum measured beam quality, an average measured beam quality, a measured beam quality for the best beam, or a measured beam quality for the worst beam of the indicated beams is greater than the threshold, and that the UE grouping criteria is not satisfied if the minimum measured beam quality, the average measured beam quality, the measured beam quality for the best beam, or the measured beam quality for the worst beam of the indicated beams is less than or equal to the threshold.

The first UE 102a transmits 310a/316, to the network entity 104, an indicator of the UE grouping status. The indicator may be a beam report for the measured set of CMRs, as illustrated in the diagram 350, or a UE grouping status report, as illustrated in the diagram 300. The first UE 102a may transmit the indicator via PUCCH, e.g., where the network entity 104 configures 304a the PUCCH resource through RRC signaling or indicates the PUCCH resource through the MAC-CE or DCI, such as by a PUCCH resource index in the control signaling transmitted 312 to the first UE 102a. In other implementations, the first UE 102a may transmit the indicator via PUSCH. The network entity 104 may configure the PUSCH resource, e.g., time-domain and frequency-domain resource, MCS, DMRS port(s), etc., through the RRC signaling or schedule the PUSCH resource through the MAC-CE or DCI. In still further implementations, the first UE 102a may transmit the indicator via PRACH. The network entity 104 may configure at least two PRACH resources through the RRC signaling or indicate the at least two PRACH resources through the MAC-CE or DCI. In examples, the network entity 104 indicates the at least two PRACH resources the control signaling transmitted 312 to the first UE 102a. At least one of the configured/indicated PRACH resources may correspond to positive indicator for the UE grouping status and the remaining configured/indicated PRACH resource may correspond to a negative indicator for the UE grouping status.

In some implementations, the first UE 102a transmits 310a/316, to the network entity 104, the indicator of the UE grouping status responsive to the first UE 102a detecting that the UE grouping criteria is not satisfied. If the first UE 102a detects that the UE grouping criteria is satisfied, the first UE 102a refrains from transmitting the indicator to the network entity 104. In further implementations, the first UE 102a transmits 310a/316, to the network entity 104, the indicator of the UE grouping status responsive to the first UE 102a detecting that the UE grouping criteria is satisfied. If the first UE 102a detects that the UE grouping criteria is not satisfied, the first UE 102a refrains from transmitting the indicator to the network entity 104. The first UE 102a may transmit the indicator via PUCCH, PUSCH, or PRACH. The network entity 104 may configure 304a the PRACH resource through RRC signaling or indicate the PRACH resource through the MAC-CE or DCI, such as by indicating at least one PRACH resource in the control signaling transmitted 312 to the first UE 102a.

The first UE 102a may transmit 316 the UE status report indicator to the network entity 104, such as in the diagram 300, to indicate whether the UE grouping status has changed. If the first UE 102a detects that the UE grouping status has changed (e.g., from being satisfied to unsatisfied or from being unsatisfied to satisfied), the first UE 102a may transmit 316 a positive indicator to the network entity 104. Otherwise, the first UE 102a may transmit 316 a negative indicator to the network entity 104. In some examples, the first UE 102a only transmits 316 the UE report status indicator to the network entity 104 if the first UE 102a detects a changed UE grouping status. If the first UE 102a does not detect a change to the UE grouping status, the first UE 102a can refrain from transmitting the indicator.

In further examples, the first UE 102a may transmit either an acknowledgment (ACK) or a negative acknowledgment (NACK) if the first UE 102a detects a change in the UE grouping status. The ACK could correspond to the UE grouping status changing from unsatisfied to satisfied, or vice-versa, whereas the NACK could correspond to the UE grouping status changing from satisfied to unsatisfied, or vice-versa. The first UE 102a may transmit the indicator to the network entity 104 based on detection (or non-detection) of a UE grouping status change. If the first UE 102a detects that the UE grouping status has not changed (or vice versa), the first UE 102a may refrain from transmitting the indicator.

The network entity 104 may transmit 318 UE group update signaling that updates the UE group for a UE group-based beam report. The network entity 104 may transmit 318 the updated through control signaling/RRC signaling (e.g., RRCReconfiguration), or through the MAC-CE or DCI. The RRC signaling may indicate an update to the RNTI for reception of network-assisted information by the first UE 102a or enable/disable the previously configured RNTI. The network entity 104 may also enable or disable the UE group-based beam report and/or whether the first UE 102a determines the UE grouping criteria.

In some examples, the UE group update signaling may indicate a measurement cycle, such as DRX-M, where the network entity 104 indicates whether the DRX-M in an ON duration/state or an OFF duration/state. The network entity 104 can indicate a starting time for a DRX-M configuration, or the starting time may be predefined (e.g., DRX-M starts based on transmission 318 of the control signaling). When the DRX-M is OFF, the first UE 102a does not perform measurements for a beam report. When DRX-M is ON, the first UE 102a may perform measurements for the beam report. The UE group update signaling may update the beam report periodicity for a beam report configuration for periodic or semi-persistent beam reports. The network entity 104 may transmit 318 the UE group update signaling to activate or deactivate the beam report configuration.

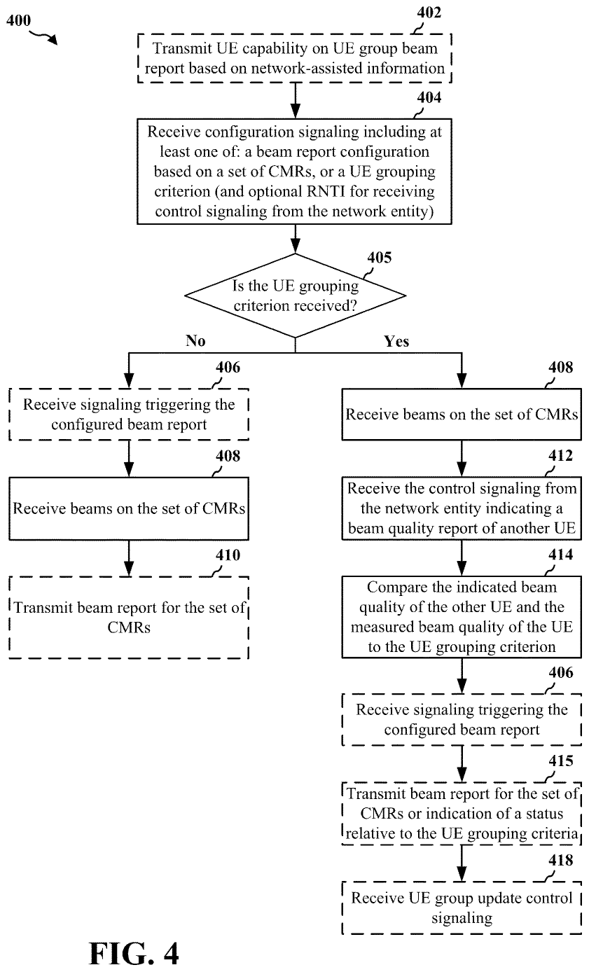

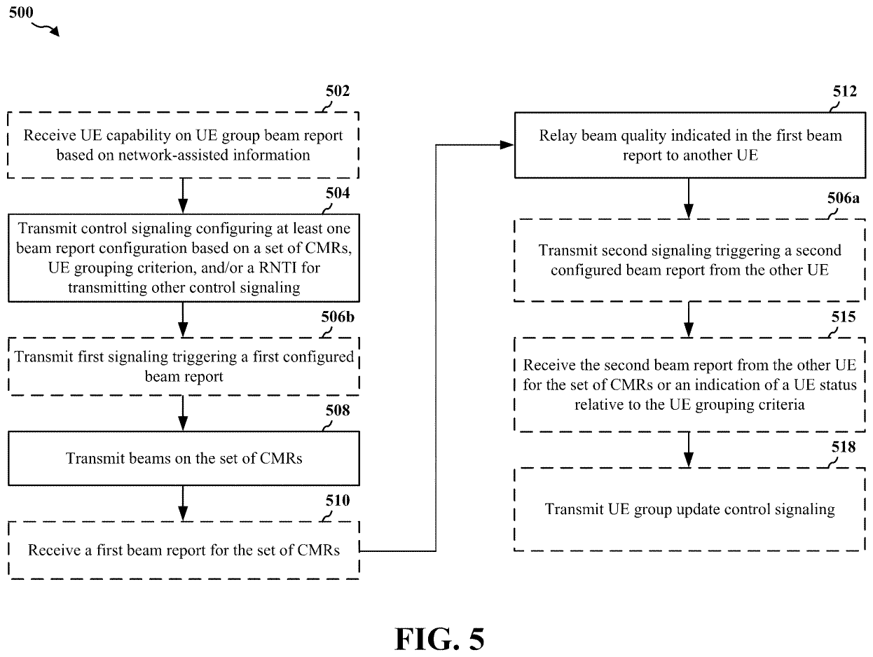

The UE group update signaling may indicate that the first UE 102a is a leader UE of the UE group. Hence, the first UE 102a may transmit 320, to the network entity 104 (e.g., based on a measurement of the CMRs 308), a single UE group beam report that indicates information for the whole UE group. FIGS. 3A-3B describes relaying beam report information from the second UE 102b to the first UE 102a through the network entity 104, whereas FIGS. 4-5 show methods for implementing one or more aspects of FIGS. 3A-3B. In particular, FIG. 4 shows an implementation by the UE 102 of the one or more aspects of FIG. 3A-3B. FIG. 5 shows an implementation by the network entity 104 of the one or more aspects of FIG. 3A-3B.

FIG. 4 illustrates a flowchart 400 of a method of wireless communication at a UE 102 for UE grouping based on network-assisted information. For example, the UE 102 transmits 402 a UE capability on UE group beam report based on network-assisted information. Referring to FIGS. 3A-3B, the UE 102 transmits 302, to the network entity 104, a UE capability on a UE group-based beam report with network-assisted information.

The UE 102 receives 404 configuration signaling indicating at least one of: a beam report configuration based on a set of CMRs, or a UE grouping criterion (and optional RNTI for receiving control signaling from the network entity). For example, referring to FIGS. 3A-3B, the UEs 102a-102b receive 304a-304b, from the network entity 104, a beam report configuration for a set of CMRs 308. The first UE 102a also receives 304a, from the network entity 104, UE-grouping criteria and an optional RNTI for receiving 312 the control signaling.

The UE 102 determines 405 whether the UE grouping criterion is received. If the UE 102 determines 405 that the UE grouping criterion is not received, the UE 102 receives 406 signaling triggering the configured beam report. For example, referring to FIGS. 3A-3B, the second UE 102b receives 306b, from the network entity 104, a triggering indication for a beam report. The UE 102 receives 408 beams on the set of CMRs. For example, referring to FIGS. 3A-3B, the second UE 102b performs a measurement on the set of CMRs 308, such that the UE 102 transmits 410 a beam report for the set of CMRs. For example, referring to FIGS. 3A-3B, the second UE 102b transmits 310b, to the network entity 104, the beam report for the measured set of CMRs 308.

If the UE 102 determines 405 that the UE grouping criterion is received, the UE 102 receives 408 the beams on the set of CMRs. For example, referring to FIGS. 3A-3B, the first UE 102a performs a measurement on the set of CMRs 308.

The UE 102 receives 412 the control signaling from the network entity indicating a beam quality report of another UE. For example, referring to FIGS. 3A-3B, the fist UE 102a receives 312, from the network entity 104, control signaling indicating a beam quality reported by the second UE 102b.

The UE 102 compares 414 the indicated beam quality of the other UE and the measured beam quality of the UE to the UE grouping criterion. For example, referring to FIGS. 3A-3B, the first UE 102a determines 314 whether the measured beam quality for the set of CMRs 308 and the indicated beam quality satisfy the UE grouping criteria.

In some implementations, the UE 102 receives 406 signaling triggering the configured beam report. For example, referring to FIG. 3B, the first UE 102a receives 306a, from the network entity 104, a triggering indication for the beam report.

The UE 102 transmits 415 the beam report for the set of CMRs or indication of a status relative to the UE grouping criteria. For example, referring to FIG. 3B, the first UE 102a transmits 310a, to the network entity 104, a beam report for the measured set of CMRs 308. Referring to FIG. 3A, the first UE 102a transmits 316, to the network entity 104, a UE status report indicating whether the UE-grouping criteria is satisfied.

The UE 102 receives 418 UE group update control signaling. For example, referring to FIGS. 3A-3B, the UE 102 receives 318, from the network entity 104, UE group update signaling (e.g., to update a status of the UE group). FIG. 4 describes a method from a UE-side of a wireless communication link, whereas FIG. 5 describes a method from a network-side of the wireless communication link.

FIG. 5 illustrates a flowchart 500 of a method of wireless communication at a network entity 104 for UE grouping based on network-assisted information. For example, the network entity 104 receives 502 a UE capability on UE group beam report based on network-assisted information. Referring to FIGS. 3A-3B, the network entity 104 receives 302, from the UEs 102a-102b, a UE capability on a UE group-based beam report with network-assisted information.

The network entity 104 transmits 504 control signaling configuring at least one beam report configuration based on a set of CMRs, UE grouping criterion, and/or a RNTI for transmitting other control signaling. For example, referring to FIGS. 3A-3B, the network entity 104 transmits 304a-304b, to the UEs 102a-102b, a beam report configuration for a set of CMRs 308. The network entity 104 also transmits 304a, to the first UE 102a, UE-grouping criteria and an optional RNTI for transmitting 312 the control signaling.

The network entity 104 transmits 506b first signaling triggering a first configured beam report. For example, referring to FIGS. 3A-3B, the network entity 104 transmits 306b, to the second UE 102b, a triggering indication for a beam report.

The network entity 104 transmits 508 beams on the set of CMRs. For example, referring to FIGS. 3A-3B, the network entity 104 transmits, to the UEs 102a-102b, beams on the configured set of CMRs 308.

The network entity 104 receives 510 a first beam report for the set of CMRs. For example, referring to FIGS. 3A-3B, the network entity 104 receives 310b, from the second UE 102b, a beam report for the measured set of CMRs 308.

The network entity 104 relays 512 a beam quality indicated in the first beam report to another UE. For example, referring to FIGS. 3A-3B, the network entity 104 transmits 312, to the first UE 102a, control signaling indicating a beam quality reported by the second UE 102b.

In some implementations, the network entity 104 transmits 506a second signaling triggering a second configured beam report from the other UE. For example, referring to FIG. 3B, the network entity 104 transmits 306a, to the first UE 102a, a triggering indication for the beam report.

The network entity 104 receives 515 the second beam report from the other UE for the set of CMRs or an indication of a UE status relative to the UE grouping criteria. For example, referring to FIG. 3B, the network entity 104 receives 310a, from the first UE 102a, a beam report for the measured set of CMRs 308. Referring to FIG. 3A, the network entity 104 receives 316, from the first UE 102a, a UE status report indicating whether the UE-grouping criteria is satisfied.

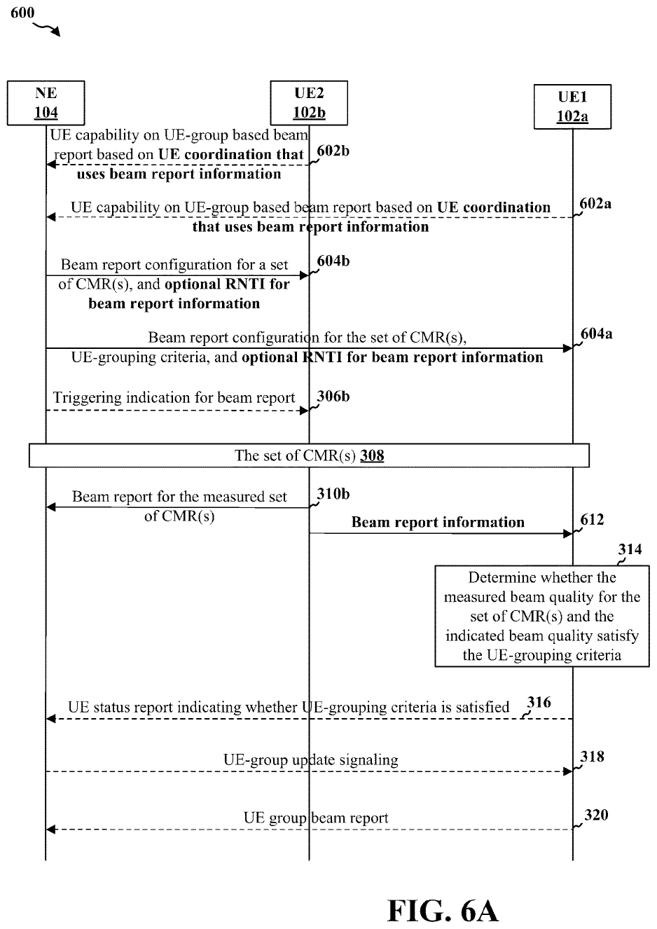

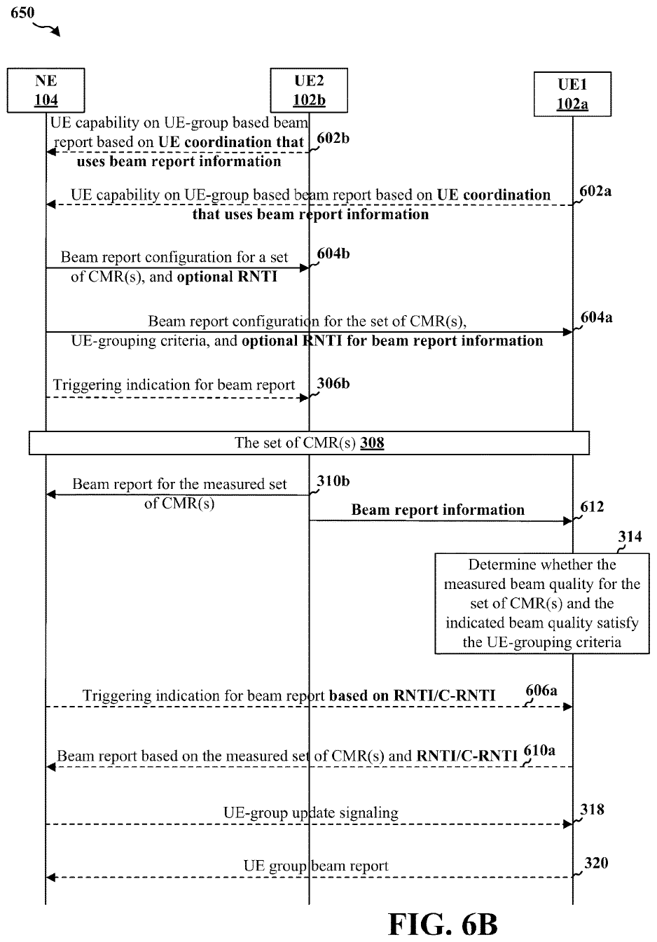

The network entity 104 transmits 518 UE group update control signaling. For example, referring to FIGS. 3A-3B, the network entity 104 transmits 318, to the first UE 102a, UE group update signaling (e.g., to update a status of the UE group). FIGS. 3A-5 describe relaying beam report information from the second UE 102b to the first UE 102a through the network entity 104, whereas FIGS. 6A-8 describe transmitting beam report information directly from the second UE 102b to the first UE 102a via sidelink communication.

FIGS. 6A-6B illustrate signaling diagrams 600-650 for a UE group beam report based on coordination among the UEs 102a-102b using beam report information. Elements 306b, 308, 310b, 314, 316, 318, and 320 have already been described with respect to FIG. 3.

The first UE 102a and the second UE 102b may report 602a-602b, to the network entity 104, a UE capability for a UE group-based beam report based on coordination among the UEs 102a-102b using beam report information. In other implementations, the network entity 104 may receive the UE capability from a core network (e.g., AMF) or from a second network entity. The UEs 102a-102b may further report 602a-602b a supported coordination message type (e.g., whether the UEs 102a-102b support UE coordination via sidelink or other technologies, such as Bluetooth, WiFi, etc.). In examples, the UEs 102a-102b may indicate a recommended coordination identifier (ID) for UEs associated with a same user (e.g., a smart watch and a handset).

The network entity 104 sends 604a-604b control signaling to the first UE 102a and the second UE 102b for a beam report configuration for the set of CMRs 308. The control signaling transmitted 604a-604b to the first UE 102a and the second UE 102b may include an optional RNTI, such as for the second UE 102b to transmit the beam report information to the first UE 102a, and for the first UE 102a to receive 612 the beam report information from the second UE 102b. The control signaling transmitted 604a to the first UE 102a may also include UE grouping criteria for the UE group. The network entity 104 may configure 604a the first UE 102a with a resource for the beam report.

In some implementations, the triggering indication transmitted 306b to the second UE for triggering 310b the beam report from the second UE 102b may be based on the configured RNTI, such that both the first UE 102a and the second UE 102b may receive the control signaling that includes the triggering indication. In other implementations, the network entity 104 transmits 306b the control signaling based on a C-RNTI for the second UE 102b, such that the first UE 102a does not receive the control signaling.

The second UE 102b may transmit 612 the beam report information to the first UE 102a via the configured RNTI for the first UE 102a to determine 314 whether the UE-grouping criteria is satisfied. Alternatively, the second UE 102b may transmit 310b the beam report based on a C-RNTI for the second UE 102b and send 612 the beam report information to the first UE 102a in a UE coordination message. The second UE 102b may transmit 612 the UE coordination message by sidelink or other techniques, such as Bluetooth, WiFi, etc.

In the diagram 650, the network entity 104 transmits 606a control signaling to the first UE 102a including a triggering indication for a beam report based on a C-RNTI for the first UE 102a. The first UE 102a may determine whether to provide the beam report based on the determination 314 of the UE-grouping criteria. In an example, if the UE-grouping criteria is satisfied, the first UE 102a does not transmit the beam report to the network entity 104. Otherwise, the first UE 102a transmits 610a, to the network entity 104, the beam report based on the measured set of CMRs and the RNTI/C-RNTI for the first UE 102a. In the diagram 600, the first UE 102a transmits 316, to the network entity 104, the UE status report indicating whether the UE-grouping criteria is satisfied.

The control signaling transmitted 604b to the second UE 102b may be RRC signaling (e.g., CSI-ReportConfig or RRCReconfiguration) indicative of the RNTI for the beam report of the second UE 102b and/or the control signaling transmitted to the first UE 102a. The control signaling may also indicate the set of CMRs 308 for beam measurement. The UEs 102a-102b may use sidelink resources (e.g., time-domain and frequency-domain resources) for sidelink communications between the UEs 102a-102b. The network entity 104 may provide the configuration for the first UE 102a and the second UE 102b to perform the UE coordination based on the beam report information via sidelink. The configuration 604b for the second UE 102b may indicate a beam report configuration ID that shares a same configuration with the first UE 102a. The configuration may also indicate a serving cell ID and/or a BWP ID that shares a beam report configuration with the first UE 102a.

The control signaling transmitted 604a to the first UE 102a may be RRC signaling (e.g., CSI-ReportConfig or RRCReconfiguration) indicative of the RNTI for the first UE 102a to receive 612 the beam report information from the second UE 102b. The network entity 104 may configure UEs in the same group with the same RNTI. If the RNTI is not configured for the first UE 102a, the first UE 102a may receive 612 the beam report information via sidelink or other techniques, such as Bluetooth, WiFi, etc. The control signaling transmitted 604a to the first UE 102a indicates resource for receiving 612 the beam report information from the second UE 102b. In some implementations, the network entity 104 configures a PUCCH resource ID to indicate the resources for the beam report. In other implementations, the network entity 104 configures a configured grant for a PUSCH to indicate the resources for the beam report. A shared beam report configuration ID indicates the beam report configuration ID that shares the same beam report configuration with the second UE 102b. A shared serving cell ID indicates the serving cell ID that shares the same beam report configuration with the second UE 102b. A shared BWP ID indicates the BWP ID that shares the beam report configuration with the second UE 102b.

The network entity 104 may transmit 306b the triggering indication via MAC-CE or DCI based on the configured RNTI or the C-RNTI of the second UE 102b. In examples, the network entity 104 transmits a PDCCH that schedules the MAC-CE used to activate a semi-persistent beam report. The network entity 104 may transmit the PDCCH and a scheduled PDSCH based on the configured RNTI. In other examples, the network entity 104 transmits a PDCCH that schedules an aperiodic beam report. The network entity 104 may transmit the PDCCH (e.g., in a Type3-CSS) based on the configured RNTI.

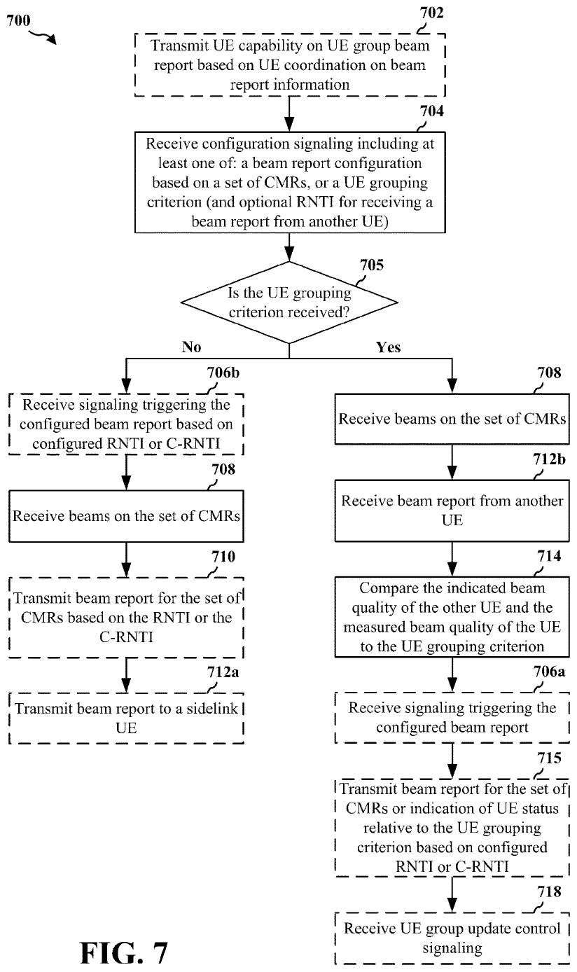

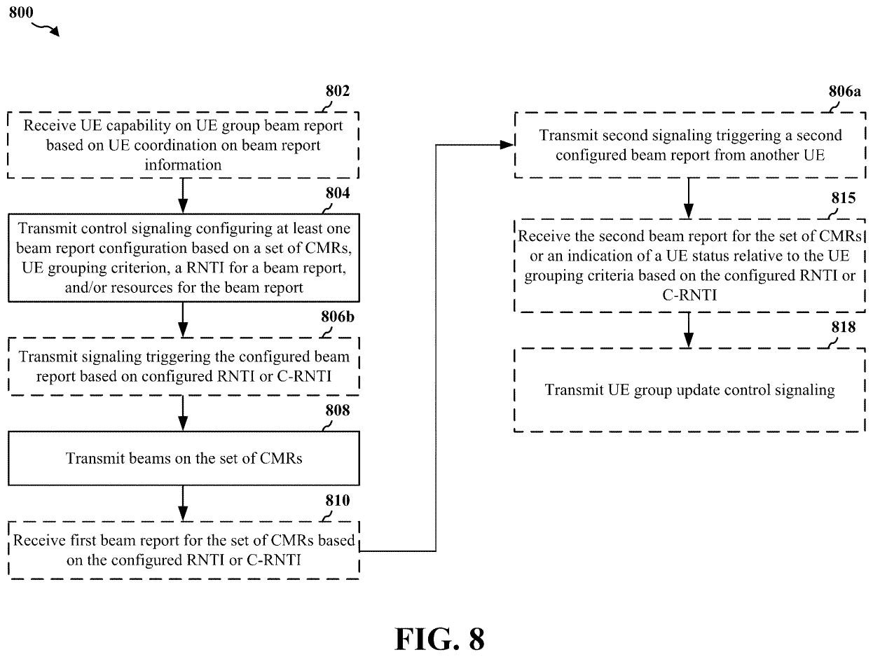

The second UE 102b may transmit 612 the beam report information to the first UE 102a by sidelink, such as on a PSSCH, based on dedicated signaling or groupcast signaling. In some implementations, the second UE 102b transmits 612 the beam report information to the first UE 102a with the reported CMR index(es) and/or the corresponding reported L1-RSRP/L1-SINR. In other implementations, the second UE 102b transmits 612 a subset of beams from the reported beams to the first UE 102a. For example, the second UE 102b transmits beams based on the N reported CMR index(es) and/or the corresponding L1-RSRP/L1-SINR, where N may be predefined (e.g., N=1) or configured 604a-604b by the network entity 104 (e.g., through RRC signaling) or indicated by the second UE 102b via UE coordination signaling. If the network entity 104 configures 604a a plurality of shared beam report configurations for the first UE 102a, the second UE 102b may further indicate the CMR set index or the shared beam report configuration ID, such as the CSI-ReportConfigld. If the network entity 104 configures a plurality of shared serving cells for both of the UE 102a-102b, the second UE 102b may indicate the serving cell index to the first UE 102a. If the network entity 104 configures a plurality of shared BWPs for both of the UE 102a-102b, the second UE 102b may indicate the BWP index to the first UE 102a. FIGS. 6A-6B describe UE coordination using beam report information, whereas FIGS. 7-8 show methods for implementing one or more aspects of FIGS. 6A-6B. In particular, FIG. 7 shows an implementation by the UE 102 of the one or more aspects of FIGS. 6A-6B. FIG. 8 shows an implementation by the network entity 104 of the one or more aspects of FIG. 6A-6B.

FIG. 7 illustrates a flowchart 700 of a method of wireless communication at a UE 102 for UE grouping based on UE coordination of beam report information. For example, the UE 102 transmits 702 a UE capability on UE group beam report based on UE coordination on beam report information. Referring to FIGS. 6A-6B, the UE 102 transmits 602, to the network entity 104, a UE capability on a UE group-based beam report based on UE coordination that uses beam report information.

The UE 102 receives 704 configuration signaling including at least one of: a beam report configuration based on a set of CMRs, or a UE grouping criterion (and optional RNTI for receiving a beam report from another UE). For example, referring to FIGS. 6A-6B, the UEs 102a-102b receive 604a-604b, from the network entity 104, a beam report configuration for a set of CMRs 308 and an optional RNTI for the beam report information. The first UE 102a also receives 604a, from then network entity 104, UE-grouping criteria.

The UE 102 determines 705 whether the UE grouping criterion is received. If the UE 102 determines 705 that the UE grouping criterion is not received, the UE 102 receives 706b signaling triggering the configured beam report based on the configured RNTI or C-RNTI. For example, referring to FIGS. 6A-6B, the second UE 102b receives 306b, from the network entity 104, a triggering indication for a beam report. The UE 102 receives 708 beams on the set of CMRs. For example, referring to FIGS. 6A-6B, the second UE 102b performs a measurement on the set of CMRs 308, such that the UE 102 transmits 710 a beam report for the set of CMRs based on the RNTI or the C-RNTI. For example, referring to FIGS. 6A-6B, the second UE 102b transmits 310b, to the network entity 104, the beam report for the measured set of CMRs 308. The UE 102 can also transmit 712a the beam report to a sidelink UE. For example, referring to FIGS. 6A-6B, the second UE 102b transmits 612 beam report information to the first UE 102a.

If the UE 102 determines 705 that the UE grouping criterion is received, the UE 102 receives 708 the beams on the set of CMRs. For example, referring to FIGS. 6A-6B, the first UE 102a performs a measurement on the set of CMRs 308.

The UE 102 receives 712b the beam report from another UE. For example, referring to FIGS. 6A-6B, the first UE 102a receives 612 beam report information from the second UE 102b.

The UE 102 compares 714 the indicated beam quality of the other UE and the measured beam quality of the UE to the UE grouping criterion. For example, referring to FIGS. 6A-6B, the first UE 102a determines 314 whether the measured beam quality for the set of CMRs 308 and the indicated beam quality satisfy the UE-grouping criteria.

In some implementations, the UE 102 receives 706a signaling triggering the configured beam report. For example, referring to FIG. 6B, the first UE 102a receives 606a, from the network entity 104, a triggering indication for the beam report based on the RNTI/C-RNTI.

The UE 102 transmits 715 the beam report for the set of CMRs or indication of UE status relative to the UE grouping criterion based on configured RNTI or C-RNTI. For example, referring to FIG. 6B, the first UE 102a transmits 610a, to the network entity 104, a beam report for the measured set of CMRs 308. Referring to FIG. 6A, the first UE 102a transmits 316, to the network entity 104, a UE status report indicating whether the UE-grouping criteria is satisfied.

The UE 102 receives 718 UE group update control signaling. For example, referring to FIGS. 6A-6B, the UE 102 receives 318, from the network entity 104, UE group update signaling (e.g., to update a status of the UE group). FIG. 7 describes a method from a UE-side of a wireless communication link, whereas FIG. 8 describes a method from a network-side of the wireless communication link.

FIG. 8 illustrates a flowchart 800 of a method of wireless communication at a network entity 104 for UE grouping based on UE coordination of beam report information. For example, the network entity 104 receives 802 a UE capability on UE group beam report based on UE coordination on beam report information. Referring to FIGS. 6A-6B, the network entity 104 receives 602, from the UEs 102a-102b, a UE capability on a UE group-based beam report based on UE coordination that uses beam report information.

The network entity 104 transmits 804 control signaling configuring at least one beam report configuration based on a set of CMRs, UE grouping criterion, a RNTI for a beam report, and/or resources for the beam report. For example, referring to FIGS. 6A-6B, the network entity 104 transmits 604a-604b, to the UEs 102a-102b, a beam report configuration for a set of CMRs 308 and an optional RNTI for the beam report information. The network entity 104 also transmits 604a, to the first UE 102a, UE-grouping criteria.

The network entity 104 transmits 806b signaling triggering the configured beam report based on configured RNTI or C-RNTI. For example, referring to FIGS. 6A-6B, the network entity 104 transmits 306b, to the second UE 102b, a triggering indication for a beam report.

The network entity 104 transmits 808 beams on the set of CMRs. For example, referring to FIGS. 6A-6B, the network entity 104 transmits, to the UEs 102a-102b, beams on the configured set of CMRs 308.

The network entity 104 receives 810 a first beam report for the set of CMRs based on the configured RNTI or C-RNTI. For example, referring to FIGS. 6A-6B, the network entity 104 receives 310b, from the second UE 102b, the beam report for the measured set of CMRs 308.

In some implementations, the network entity 104 transmits 806a second signaling triggering a second configured beam report from another UE. For example, referring to FIG. 6B, the network entity 104 transmits 606a, to the first UE 102a, a triggering indication for the beam report based on the RNTI/C-RNTI.

The network entity 104 receives 815 the second beam report for the set of CMRs or an indication of a UE status relative to the UE grouping criteria based on the configured RNTI or C-RNTI. For example, referring to FIG. 6B, the network entity 104 receives 610a, from the first UE 102a, a beam report for the measured set of CMRs 308. Referring to FIG. 6A, the network entity 104 receives 316, from the first UE 102a, a UE status report indicating whether the UE-grouping criteria is satisfied.

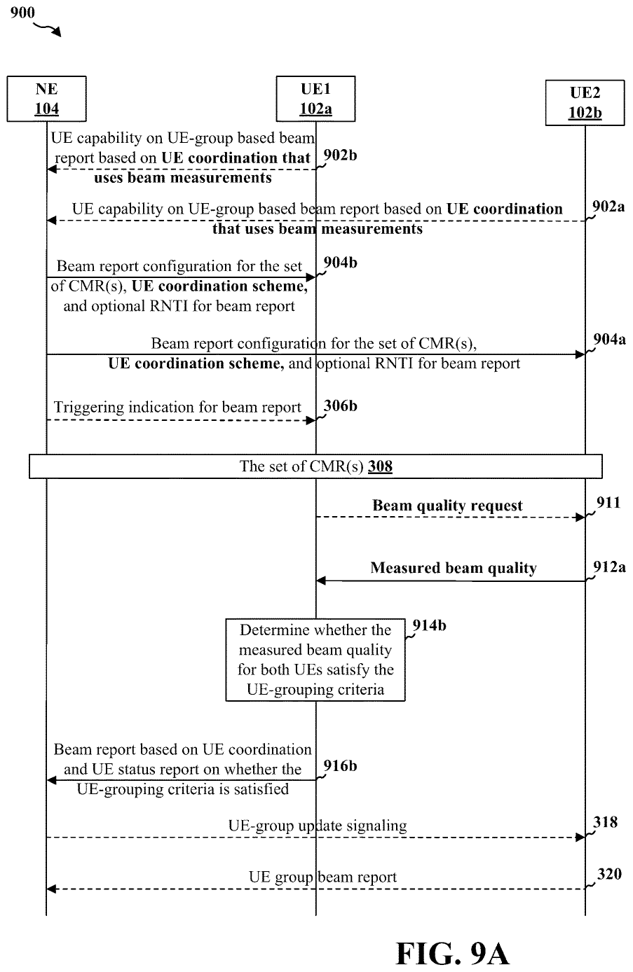

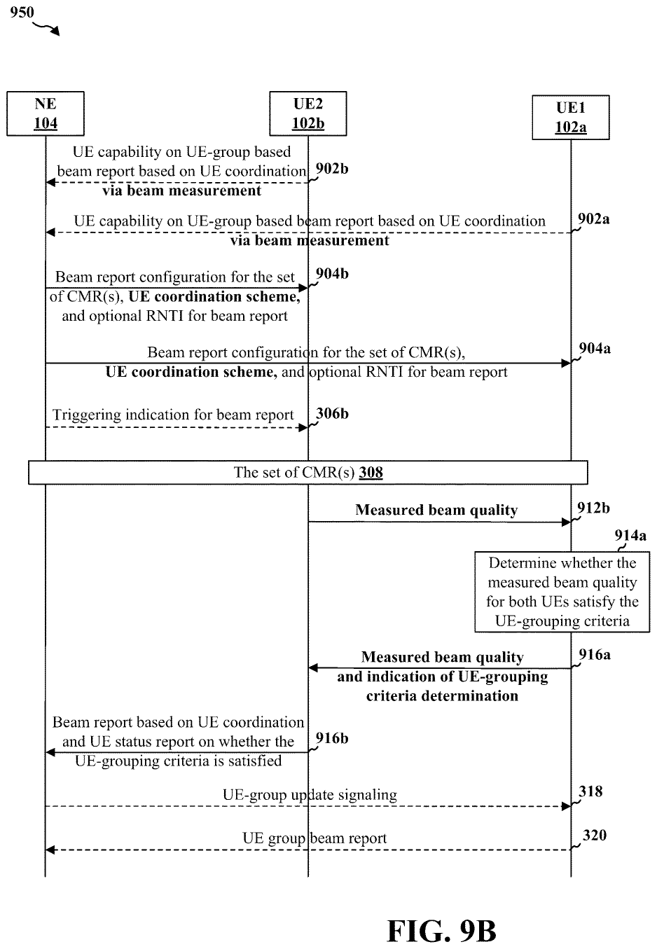

The network entity 104 transmits 818 UE group update control signaling. For example, referring to FIGS. 6A-6B, the network entity 104 transmits 318, to the first UE 102a, UE group update signaling (e.g., to update a status of the UE group). FIGS. 6A-8 describe UE coordination using beam report information, whereas FIGS. 9A-11 describe UE coordination using beam measurements.

FIGS. 9A-9B illustrate signaling diagrams 900-950 for a UE group beam report based on coordination among the UEs 102a-102b via beam measurement. Elements 306b, 308, 318, and 320 have already been described with respect to FIG. 3.

The first UE 102a and the second UE 102b may report 902a-902b, to the network entity 104, a UE capability for a UE group-based beam report based on coordination among the UEs 102a-102b via beam measurements. In other implementations, the network entity 104 may receive the UE capability from a core network (e.g., AMF) or from a second network entity. The UEs 102a-102b may indicate whether the UEs 102a-102b support beam report transmission when the UE-group based beam report is enabled (e.g., whether a reporting UE is the UE transmitting the beam report or the UE assisting with the beam measurement).

The network entity 104 may configure 904a-904b a UE coordination scheme based on the beam measurement of the UEs 102a-102b. The UE coordination scheme may indicate whether to enable beam report procedures or whether to transmit a beam based on a minimum, maximum, or average beam quality (e.g., based on the L1-RSRP/L1-SINR for the beam measured by the coordinating UEs 102a-102b).

In the diagram 900, the first UE 102a transmits 911 a beam quality request to the second UE 102b via sidelink (e.g., PSCCH or PSSCH). The second UE 102b transmit 912a (e.g., in response to the beam quality request) the measured beam quality to the first UE 102a via sidelink (e.g., PSSCH). The first UE 102a determines 914b whether the measured beam quality for both UEs 102a-102b satisfy the UE-grouping criteria. The first UE 102a transmits 916b a beam report to the network entity 104 based on the UE coordination scheme as well as a UE status report on whether the UE-grouping criteria is satisfied.

The measured beam quality may correspond to M measured beams. A beam index for the M measured beams may be indicated by the first UE 102a or reported by the second UE 102b. A value of M may be predefined or indicated by the first UE 102a. The first UE 102a may refrain from transmitting the beam quality request to the second UE 102b, if the triggering indication received 306b from the network entity 104 is based on the RNTI for the second UE 102b, as the second UE 102b can also receive the triggering indication from the network entity 104 in some implementations. Alternatively, the UEs 102a-102b may perform UE coordination of the beam measurements using other techniques, such as Bluetooth, WiFi, etc.

In the diagram 950, the second UE 102b transmits 912b a measured beam quality to the first UE 102a for the first UE 102a to determine 914a whether the measured beam quality for both UEs satisfies the UE-grouping criteria. The first UE 102a sends 916a, to the second UE 102b, an indication of the measured beam quality by the first UE 102a as well as an indication of the UE-grouping criteria determination for the second UE 102b to relay 916b the information to the network entity 104. That is, the second UE 102b transmits 916b a beam report to the network entity 104 indicative of the information received 916a from the first UE 102a.

The control signaling transmitted 904a-904b to the UEs 102a-102b through the RRC signaling (e.g., CSI-ReportConfig or RRCReconfiguration) may indicate the UE coordination scheme, which may further indicate whether the UEs 102a-102b perform beam report procedures. Beam measurements may also indicate whether the UEs 102a-102b should transmit the minimum, maximum, or average beam quality (e.g., L1-RSRP/L1-SINR for a beam measured by the coordinated UEs 102a-102b). A beam measurement scheme may correspond to the reported L1-RSRP/L1-SINR, if at least the L1-RSRP/L1-SINR is measured by the UEs 102a-102b.

The UE 102 transmits 916b the beam report to the network entity 104 based on the UE-coordinated beam measurement results and an indicator of the UE-grouping status (e.g., whether the UE-grouping criteria is satisfied). The UE 102 may transmit 916b the beam report and the UE-grouping status indicator on a PUCCH or PUSCH. In other implementations, the UE-grouping status indicator may be an implicit indication via PUCCH or PUSCH. The network entity 104 can configure at least two PUCCH resources by RRC signaling or indicate at least two PUCCH resources by MAC-CE or DCI. A first PUCCH resource may correspond to a positive UE-grouping status indicator and a second PUCCH resource may correspond to a negative UE-grouping status indicator. For a PUSCH indication, the network entity 104 may configure at least two scrambling IDs for the PUSCH or a DMRS of the PUSCH by RRC signaling or may indicate the at least two scrambling IDs by MAC-CE or DCI. The first scrambling ID may correspond to the positive UE-grouping status indicator and the second scrambling ID may correspond to the negative UE-grouping status indicator. The UE 102 can select the corresponding PUCCH resource or the scrambling ID based on the UE-grouping status to transmit 916b the beam report to the network entity 104 on either the selected PUCCH resource or on the PUSCH with the selected scrambling ID.

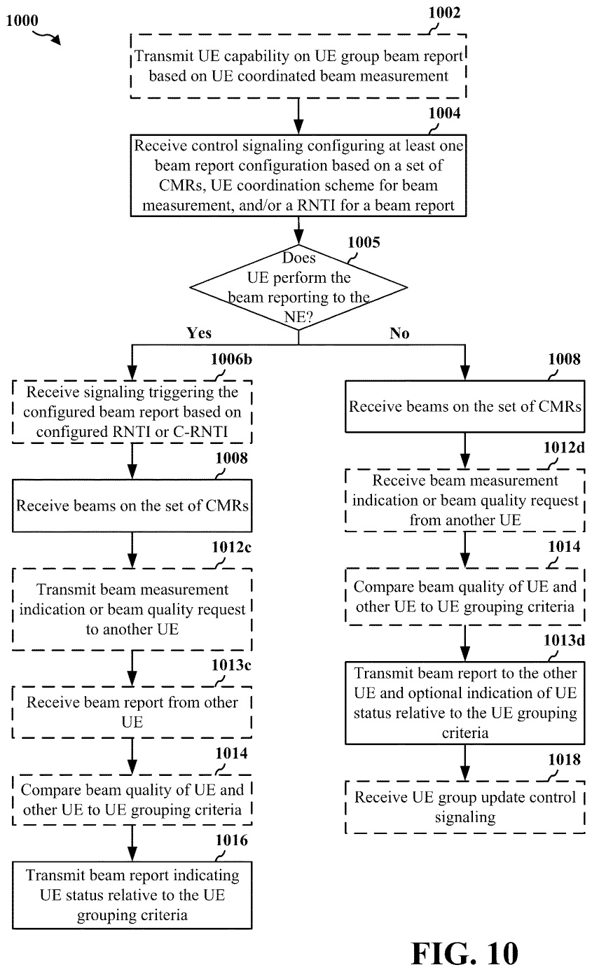

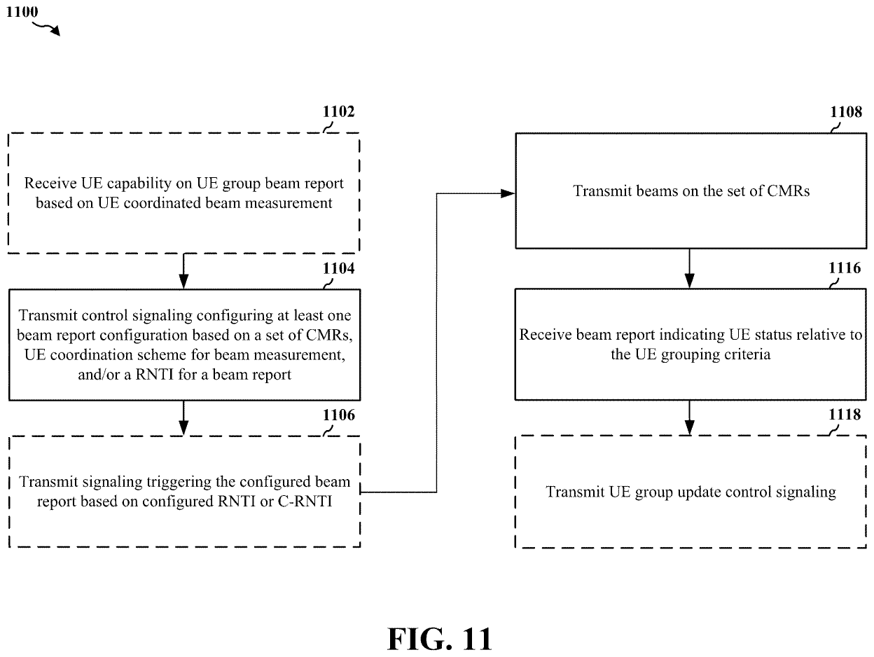

The UE 102 may transmit 916 the beam report based on the UE-coordinated beam measurement results and an indicator to the network entity 104 indicating the UE-grouping status for each UE in the group (e.g., whether the UE-grouping criteria is satisfied on a per UE basis). The UE 102 may transmit 916 the beam report with a bitmap indicating the UE-grouping status for each UE via PUCCH or PUSCH. For example, bit X in the bitmap indicates the UE-grouping status for UE X. In an example, a value of 1 indicates the positive UE-grouping status and a value of 0 indicates the negative UE-grouping status. FIGS. 9A-9B describe UE coordination using beam report information, whereas FIGS. 10-11 show methods for implementing one or more aspects of FIGS. 9A-9B. In particular, FIG. 10 shows an implementation by the UE 102 of the one or more aspects of FIGS. 9A-9B. FIG. 11 shows an implementation by the network entity 104 of the one or more aspects of FIG. 9A-9B.

FIG. 10 illustrates a flowchart 1000 of a method of wireless communication at a UE 102 for UE grouping based on UE coordination of beam measurements. For example, the UE 102 transmits 1002 a UE capability on UE group beam report based on UE coordinated beam measurement. Referring to FIGS. 9A-9B, the UE 102 transmits 902, to the network entity 104, a UE capability on a UE group-based beam report based on UE coordination that uses beam measurements.

The UE 102 receives 1004 control signaling configuring at least one beam report configuration based on a set of CMRs, UE coordination scheme for beam measurement, and/or a RNTI for a beam report. For example, referring to FIGS. 9A-9B, the UEs 102a-102b receive 904a-904b, from the network entity 104, a beam report configuration for a set of CMRs 308, a UE coordination scheme, and an optional RNTI for the beam report.

The UE 102 determines 1005 whether to perform the beam reporting to the network entity. If the UE 102 determines 1005 to perform the beam reporting to the network entity, the UE 102 may receive 1006b signaling triggering the configured beam report based on a configured RNTI or C-RNTI. For example, referring to FIG. 9A, the first UE 102a receives 306b, from the network entity 104, a triggering indication for a beam report.

The UE 102 receives 1008 beams on the set of CMRs. For example, referring to FIGS. 9A-9B, the UEs 102a-102b perform measurements on the set of CMRs 308, such that the UE 102 transmits 1012c a beam measurement indication or a beam quality request to another UE. For example, referring to FIG. 9B, the second UE 102b transmits 912, to the first UE 102a, a measured beam quality. Referring to FIG. 9A, the first UE 102a transmits 911, to the second UE 102b, a beam quality request.

The UE 102 receives 1013c a beam report from another UE. For example, referring to FIG. 9A, the first UE 102a receives 912a, from the second UE 102b, a measured beam quality. Referring to FIG. 9B, the second UE 102b receives 916a, from the first UE 102a, a measured beam quality and an indication of a UE-grouping The UE 102 compares 1014 a beam quality of UE and the other UE to UE grouping criteria. For example, referring to FIGS. 9A-9b, the UEs 102a-102b determine 914a-914b whether the measured beam quality of both UEs 102a-102b satisfy the UE-grouping criteria.

The UE 102 transmits 1016 a beam report indicating UE status relative to the UE grouping criteria. For example, referring to FIG. 9A, the first UE 102a transmits 916b, to the network entity 104 a beam report based on UE coordination and a UE status report on whether the UE-grouping criteria is satisfied. Referring to FIG. 9B, the first UE 102a transmits 916, to the second UE 102b, a report of the measured beam quality and the indication of the UE-grouping criteria determination, and the second UE 102b relays 916b the indication of the UE-grouping criteria determination to the network entity 104.

If the UE 102 determines 1005 not to perform the beam reporting to the network entity, the UE 102 receives 1008 the beams on the set of CMRs, as described above, such that the UE 102 may receive 1012d a beam measurement indication or a beam quality request from another UE. For example, referring to FIG. 9B, the first UE 102b receives 912, to the second UE 102b, a measured beam quality. Referring to FIG. 9A, the second UE 102b receives 911, from the first UE 102a, a beam quality request.

The UE 102 compares 1014 a beam quality of UE and the other UE to UE grouping criteria. For example, referring to FIGS. 9A-9b, the UEs 102a-102b determine 914a-914b whether the measured beam quality of both UEs 102a-102b satisfy the UE-grouping criteria.

The UE 102 transmits 1013d the beam report to the other UE and optional indication of UE status relative to the UE grouping criteria. For example, referring to FIG. 9B, the first UE 102a transmits 916a, to the second UE 102b, the measured beam quality and the indication of the UE-grouping criteria determination.

The UE 102 receives 1018 UE group update control signaling. For example, referring to FIGS. 9A-9B, the UE 102 receives 318, from the network entity 104, UE group update signaling (e.g., to update a status of the UE group). FIG. 10 describes a method from a UE-side of a wireless communication link, whereas FIG. 11 describes a method from a network-side of the wireless communication link.

FIG. 11 illustrates a flowchart 1100 of a method of wireless communication at a network entity 104 for UE grouping based on UE coordination of beam measurements. For example, the network entity 104 receives 1102 a UE capability on UE group beam report based on UE coordinated beam measurement. Referring to FIGS. 9A-9B, the network entity 104 receives 902, from the UEs 102a-102b, a UE capability on a UE group-based beam report based on UE coordination that uses beam measurements.

The network entity 104 transmits 1104 control signaling configuring at least one beam report configuration based on a set of CMRs, UE coordination scheme for beam measurement, and/or a RNTI for a beam report. For example, referring to FIGS. 9A-9B, the network entity 104 transmits 904a-904b, to the UEs 102a-102b, a beam report configuration for a set of CMRs 308, a UE coordination scheme, and an optional RNTI for the beam report.

The network entity 104 transmits 1106 signaling triggering the configured beam report based on the configured RNTI or C-RNTI. For example, referring to FIG. 9A, the network entity 104 transmits 306b, to the first UE 102a, a triggering indication for the beam report.

The network entity 104 transmits 1108 beams on the set of CMRs, such that the network entity 104 receives 1116 the beam report indicating the UE status relative to the UE grouping criteria. For example, referring to FIG. 9A, the network entity 104 receives 916b, from the first UE 102a, a beam report based on UE coordination and a UE status report on whether the UE-grouping criteria is satisfied. Referring to FIG. 9B, the network entity 104 receives 916, from the first UE 102a, the beam report based on the measured beam quality and the indication of the UE-grouping criteria determination being relayed 916b, by the second UE 102b, from the first UE 102a to the network entity 104.

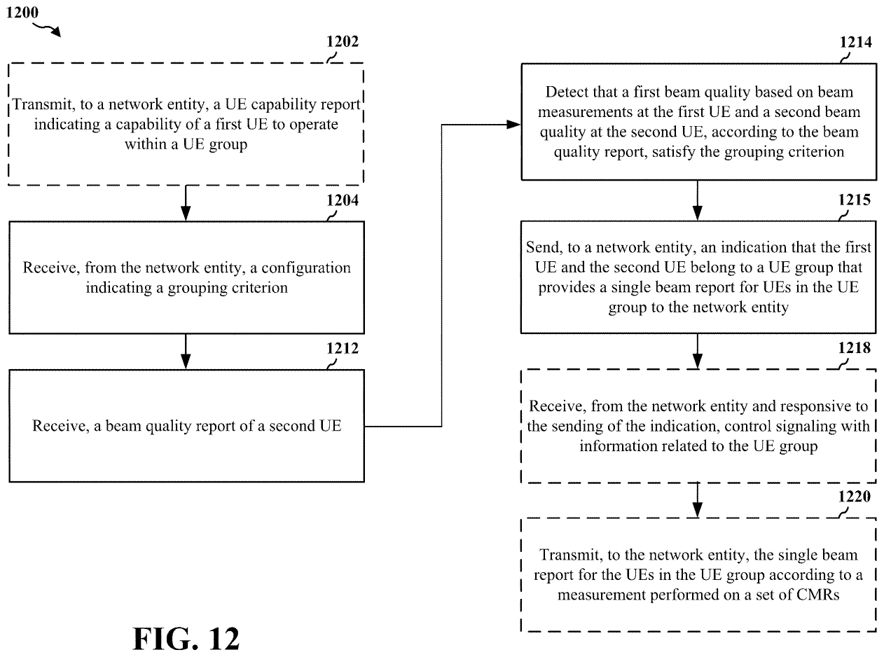

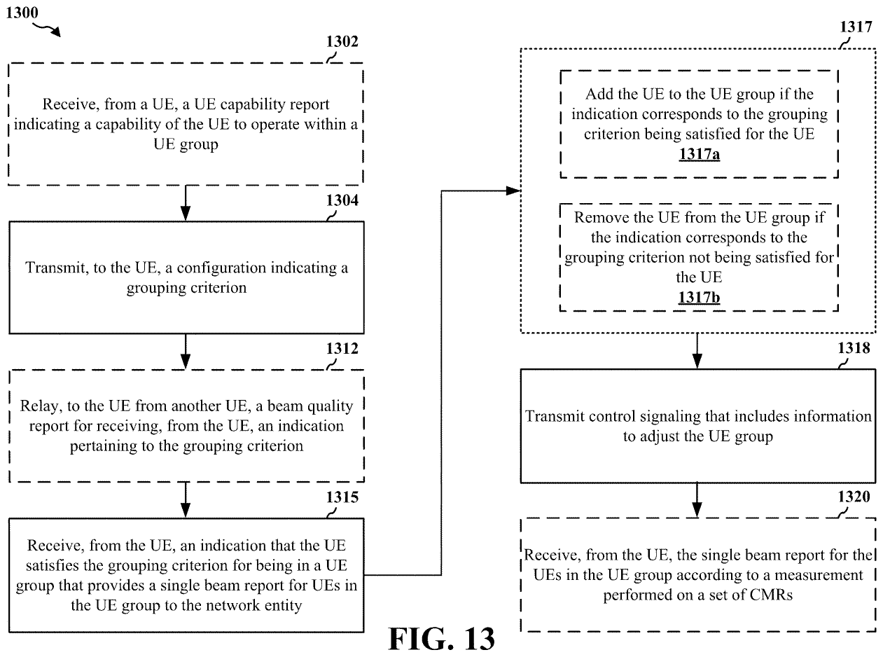

The network entity 104 transmits 1118 UE group update control signaling. For example, referring to FIGS. 9A-9B, the network entity 104 transmits 318, to the UE 102, UE group update signaling (e.g., to update a status of the UE group). FIGS. 2A-11 illustrate procedures for sending 320, to a network entity 104, a single beam report for a group of UEs. FIGS. 12-13 show methods for implementing one or more aspects of FIGS. 2A-11. In particular, FIG. 12 shows an implementation by the UE 102 of the one or more aspects of FIGS. 2A-11. FIG. 13 shows an implementation by the network entity 104 of the one or more aspects of FIGS. 2A-11.

FIG. 12 illustrates a flowchart 1200 of a method of wireless communication at a UE. With reference to FIGS. 3A-3B, 6A-6B, 9A-9B, and 14, the method may be performed by the UE 102, the UE apparatus 1402, etc., which may include the memory 1426′, 1406′, 1416, and which may correspond to the entire UE 102 or the entire UE apparatus 1402, or a component of the UE 102 or the UE apparatus 1402, such as the wireless baseband processor 1426 and/or the application processor 1406.

The UE 102 transmits 1202, to a network entity, a UE capability report indicating a capability of a first UE to operate within a UE group. For example, referring to FIGS. 3A-3B, the UE 102 transmits 302, to the network entity 104, a UE capability on a UE group-based beam report with network-assisted information. Referring to FIGS. 6A-6B, the UE 102 transmits 602, to the network entity 104, a UE capability on a UE group-based beam report based on UE coordination that uses beam report information. Referring to FIGS. 9A-9B, the UE 102 transmits 902, to the network entity 104, a UE capability on a UE group-based beam report based on UE coordination that uses beam measurements.

The UE 102 receives 1204, from the network entity, a configuration indicating a grouping criterion. For example, referring to FIGS. 3A-3B, the first UE 102a receives 304a, from the network entity 104, a beam report configuration for a set of CMRs 308, the UE-grouping criteria, and an optional RNTI for receiving 312 the control signaling.

The UE 102 receives 1212, a beam quality report of a second UE. For example, referring to FIGS. 3A-3B, the first UE 102a receives 312, from the network entity 104, control signaling indicating a beam quality reported by the second UE 102b. Referring to FIGS. 6A-6B, the first UE 102a receives 612, from the second UE 102b, beam report information. Referring to FIGS. 9A-9B, the UE 102 receives 912 a measured beam quality of another UE.

The UE 102 detects 1214 that a first beam quality based on beam measurements at the first UE and a second beam quality at the second UE, according to the beam quality report, satisfy the grouping criterion. For example, referring to FIGS. 3A-3B and 6A-6B, the first UE 102a determines 314 whether the measured beam quality of the set of CMRs 308 and the indicated beam quality by the second UE 102b satisfy the UE-grouping criteria.

The UE 102 sends 1215, to a network entity, an indication that the first UE and the second UE belong to a UE group that provides a single beam report for UEs in the UE group to the network entity. For example, referring to FIGS. 3A, 6A, and 9A-9B, the UE 102 sends 316, 916, to the network entity 104, a UE status report indicating whether the UE-grouping criteria is satisfied. Referring to FIGS. 3B and 6B, the first UE 102a transmits 310a, 610a, to the network entity 104, a beam report based on the measured set of CMRs 308, the beam report being indicative of the grouping status.

The UE 102 receives 1218, from the network entity and responsive to the sending of the indication, control signaling with information related to the UE group. For example, referring to FIGS. 3A-3B, 6A-6B, and 9A-9B, the UE 102 receives 318, from the network entity 104, UE-group update signaling.

The UE 102 transmits 1220, to the network entity, the single beam report for the UEs in the UE group according to a measurement performed on a set of CMRs. For example, referring to FIGS. 3A-3B, 6A-6B, and 9A-9B, the UE 102 transmits 320, to the network entity 104, a UE group beam report. FIG. 12 describes a method from a UE-side of a wireless communication link, whereas FIG. 13 describes a method from a network-side of the wireless communication link.

FIG. 13 is a flowchart 1300 of a method of wireless communication at a network entity. With reference to FIGS. 3A-3B, 6A-6B, 9A-9B, and 15, the method may be performed by one or more network entities 104, which may correspond to a base station or a unit of the base station, such as the RU 106, the DU 108, the CU 110, an RU processor 1506, a DU processor 1526, a CU processor 1546, etc. The one or more network entities 104 may include memory 1506′/1526′/1546′, which may correspond to an entirety of the one or more network entities 104, or a component of the one or more network entities 104, such as the RU processor 1506, the DU processor 1526, or the CU processor 1546.

The network entity 104 receives 1302, from a UE, a UE capability report indicating a capability of the UE to operate within a UE group. For example, referring to FIGS. 3A-3B, the network entity 104 receives 302, from the UE 102, a UE capability on a UE group-based beam report with network-assisted information. Referring to FIGS. 6A-6B, the network entity 104 receives 602, from the UE 102, a UE capability on a UE group-based beam report based on UE coordination that uses beam report information. Referring to FIGS. 9A-9B, the network entity 104 receives 902, from the UE 102, a UE capability on a UE group-based beam report based on UE coordination that uses beam measurements.

The network entity 104 transmits 1304, to the UE, a configuration indicating a grouping criterion. For example, referring to FIGS. 3A-3B, the network entity 104 transmits 304a, to the first UE 102a, a beam report configuration for a set of CMRs 308, the UE-grouping criteria, and an optional RNTI for transmitting 312 the control signaling.

The network entity 104 relays 1312, to the UE from another UE, a beam quality report for receiving, from the UE, an indication pertaining to the grouping criterion. For example, referring to FIGS. 3A-3B, the network entity 104 transmits 312, to the first UE 102a, control signaling indicating a beam quality reported by the second UE 102b.

The network entity 104 receives 1315, from the UE, an indication that the UE satisfies the grouping criterion for being in a UE group that provides a single beam report for UEs in the UE group to the network entity. For example, referring to FIGS. 3A, 6A, and 9A-9B, the network entity receives 316, 916, from the UE 102, a UE status report indicating whether the UE-grouping criteria is satisfied. Referring to FIGS. 3B and 6B, the network entity 104 receives 310a, 610a, from the UE 102, a beam report based on the measured set of CMRs 308, the beam report being indicative of the grouping status.

The network entity 104 may adjust 1317 the UE group responsive to receiving 1315 the indication from the UE 102. For example, the network entity 104 adds 1317a the UE to the UE group if the indication corresponds to the grouping criterion being satisfied for the UE or removes 1317b the UE from the UE group if the indication corresponds to the grouping criterion not being satisfied for the UE. For example, referring to FIGS. 3A-3B, 6A-6B, and 9A-9B, the network entity 104 adds or removes the UE 102 from the UE group via the UE group update signaling transmitted 318 to the UE 102.

The network entity 104 transmits 1318 control signaling that includes information to adjust the UE group. For example, referring to FIGS. 3A-3B, 6A-6B, and 9A-9B, the network entity 104 transmits 318, to the UE 102, the UE-group update signaling.

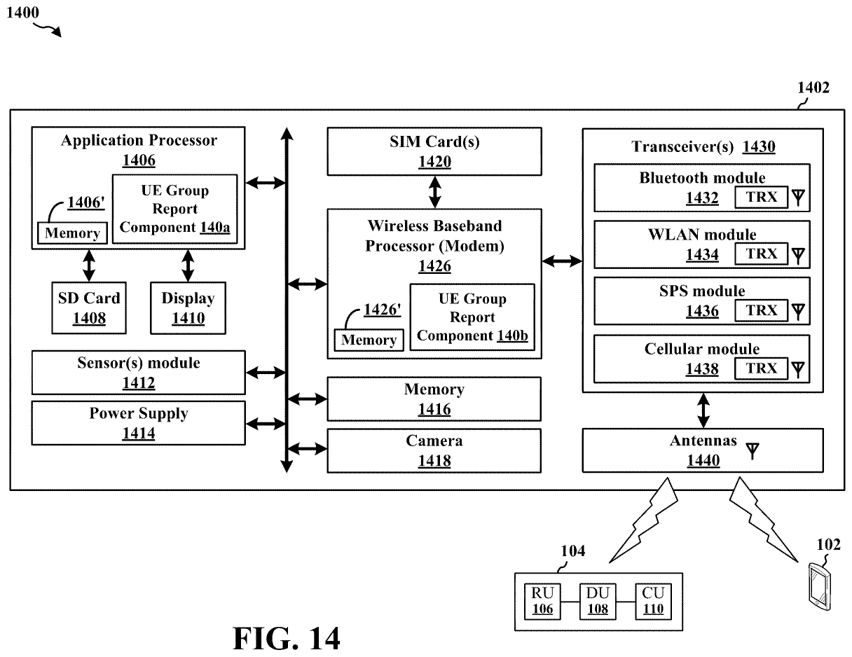

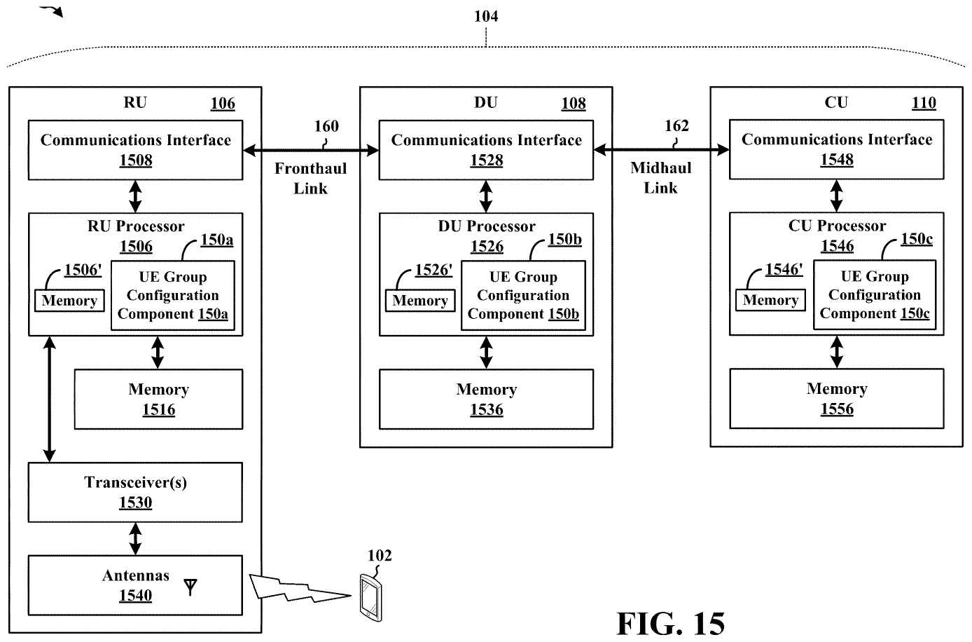

The network entity 104 receives 1320, from the UE, the single beam report for the UEs in the UE group according to a measurement performed on a set of CMRs. For example, referring to FIGS. 3A-3B, 6A-6B, and 9A-9B, the network entity 104 receives 320, from the UE 102, a UE group beam report. A UE apparatus 1402, as described in FIG. 14, may perform the method of flowchart 1200. The one or more network entities 104, as described in FIG. 15, may perform the method of flowchart 1300.

FIG. 14 is a diagram 1400 illustrating an example of a hardware implementation for a UE apparatus 1402. The UE apparatus 1402 may be the UE 102, a component of the UE 102, or may implement UE functionality. The UE apparatus 1402 may include an application processor 1406, which may have on-chip memory 1406′. In examples, the application processor 1406 may be coupled to a secure digital (SD) card 1408 and/or a display 1410. The application processor 1406 may also be coupled to a sensor(s) module 1412, a power supply 1414, an additional module of memory 1416, a camera 1418, and/or other related components. For example, the sensor(s) module 1412 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1402 may further include a wireless baseband processor 1426, which may be referred to as a modem. The wireless baseband processor 1426 may have on-chip memory 1426′. Along with, and similar to, the application processor 1406, the wireless baseband processor 1426 may also be coupled to the sensor(s) module 1412, the power supply 1414, the additional module of memory 1416, the camera 1418, and/or other related components. The wireless baseband processor 1426 may be additionally coupled to one or more subscriber identity module (SIM) card(s) 1420 and/or one or more transceivers 1430 (e.g., wireless RF transceivers).

Within the one or more transceivers 1430, the UE apparatus 1402 may include a Bluetooth module 1432, a WLAN module 1434, an SPS module 1436 (e.g., GNSS module), and/or a cellular module 1438. The Bluetooth module 1432, the WLAN module 1434, the SPS module 1436, and the cellular module 1438 may each include an on-chip transceiver (TRX), or in some cases, just a transmitter (TX) or just a receiver (RX). The Bluetooth module 1432, the WLAN module 1434, the SPS module 1436, and the cellular module 1438 may each include dedicated antennas and/or utilize antennas 1440 for communication with one or more other nodes. For example, the UE apparatus 1402 can communicate through the transceiver(s) 1430 via the antennas 1440 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1426 and the application processor 1406 may each include a computer-readable medium/memory 1426′, 1406′, respectively. The additional module of memory 1416 may also be considered a computer-readable medium/memory. Each computer-readable medium/memory 1426′, 1406′, 1416 may be non-transitory. The wireless baseband processor 1426 and the application processor 1406 may each be responsible for general processing, including execution of software stored on the computer-readable medium/memory 1426′, 1406′, 1416. The software, when executed by the wireless baseband processor 1426/application processor 1406, causes the wireless baseband processor 1426/application processor 1406 to perform the various functions described herein. The computer-readable medium/memory may also be used for storing data that is manipulated by the wireless baseband processor 1426/application processor 1406 when executing the software. The wireless baseband processor 1426/application processor 1406 may be a component of the UE 102. The UE apparatus 1402 may be a processor chip (e.g., modem and/or application) and include just the wireless baseband processor 1426 and/or the application processor 1406. In other examples, the UE apparatus 1402 may be the entire UE 102 and include the additional modules of the apparatus 1402.

As discussed, the UE group report component 140 is configured to receive, a beam quality report of a second UE; detect whether a first beam quality based on beam measurements at the first UE and a second beam quality at the second UE, according to the beam quality report, satisfy a grouping criterion; and based on the detection, send to a network entity, an indication that the first UE and the second UE belong to a UE group that provides a single beam report for UEs in the UE group to the network entity. The UE group report component 140 may be within the application processor 1406 (e.g., at 140a), the wireless baseband processor 1426 (e.g., at 140b), or both the application processor 1406 and the wireless baseband processor 1426. The UE group report component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 15 is a diagram 1500 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1546, which may have on-chip memory 1546′. In some aspects, the CU 110 may further include an additional module of memory 1556 and/or a communications interface 1548, both of which may be coupled to the CU processor 1546. The CU 110 can communicate with the DU 108 through a midhaul link 162, such as an F1 interface between the communications interface 1548 of the CU 110 and a communications interface 1528 of the DU 108.

The DU 108 may include a DU processor 1526, which may have on-chip memory 1526′. In some aspects, the DU 108 may further include an additional module of memory 1536 and/or the communications interface 1528, both of which may be coupled to the DU processor 1526. The DU 108 can communicate with the RU 106 through a fronthaul link 160 between the communications interface 1528 of the DU 108 and a communications interface 1508 of the RU 106.

The RU 106 may include an RU processor 1506, which may have on-chip memory 1506′. In some aspects, the RU 106 may further include an additional module of memory 1516, the communications interface 1508, and one or more transceivers 1530, all of which may be coupled to the RU processor 1506. The RU 106 may further include antennas 1540, which may be coupled to the one or more transceivers 1530, such that the RU 106 can communicate through the one or more transceivers 1530 via the antennas 1540 with the UE 102.

The on-chip memory 1506′, 1526′, 1546′ and the additional modules of memory 1516, 1536, 1556 may each be considered a computer-readable medium/memory. Each computer-readable medium/memory may be non-transitory. Each of the processors 1506, 1526, 1546 is responsible for general processing, including execution of software stored on the computer-readable medium/memory. The software, when executed by the corresponding processor(s) 1506, 1526, 1546 causes the processor(s) 1506, 1526, 1546 to perform the various functions described herein. The computer-readable medium/memory may also be used for storing data that is manipulated by the processor(s) 1506, 1526, 1546 when executing the software. In examples, the UE group configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed, the UE group configuration component 150 is configured to receive, from a UE, an indication that the UE satisfies a grouping criterion for being in a UE group that provides a single beam report for UEs in the UE group to the network entity; and responsive to the receiving of the indication, transmit control signaling that includes information to adjust the UE group. The UE group configuration component 150 may be within one or more processors of the one or more network entities 104, such as the RU processor 1506 (e.g., at 150a), the DU processor 1526 (e.g., at 150b), and/or the CU processor 1546 (e.g., at 150c). The UE group configuration component 150a-150c may be one or more hardware components specifically configured to carry out the stated processes/algorithm, implemented by one or more processors 1506, 1526, 1546 configured to perform the stated processes/algorithm, stored within a computer-readable medium for implementation by the one or more processors 1506, 1526, 1546, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.
Example 1 is a method of wireless communication at a UE, including: receiving, a beam quality report of a second UE; detecting whether a first beam quality based on beam measurements at the first UE and a second beam quality at the second UE, according to the beam quality report, satisfy a grouping criterion; and based on the detecting, sending to a network entity, an indication that the first UE and the second UE belong to a UE group that provides a single beam report for UEs in the UE group to the network entity.
Example 2 may be combined with Example 1 and includes that the receiving the beam quality report of the second UE includes: obtaining, from the network entity, the beam quality report of the second UE.
Example 3 may be combined with Example 1 and includes that the receiving the beam quality report of the second UE includes: obtaining, from a sidelink communication with the second UE, the beam quality report of the second UE.
Example 4 may be combined with any of Examples 1-3 and includes that the grouping criterion requires a difference between the first beam quality and the second beam quality to be within a predefined range, the first beam quality and the second beam quality being based on an amplitude or a signal-to-noise ratio for measurements performed on same signals by the first UE and the second UE.
Example 5 may be combined with any of Examples 1-4 and further includes receiving, from the network entity, a configuration indicating the grouping criterion.
Example 6 may be combined with Example 5 and includes that the configuration further indicates at least one of: a RNTI employed in the receiving of the beam quality report, a configuration identifier for the single beam report, a serving cell identifier for the single beam report, or a BWP identifier associated with the single beam report.
Example 7 may be combined with any of Examples 1-6 and includes that the sending of the indication occurs: when the grouping criterion is satisfied while the first UE is not in the UE group, or when the grouping criterion is not satisfied while the first UE is included in the group.
Example 8 may be combined with any of Examples 1-7 and further includes transmitting, to the network entity, a UE capability report indicating a capability of the first UE to operate within the UE group.
Example 9 may be combined with Example 8 and includes that the UE capability report indicates at least one of: a maximum number of measured beams to report to the network entity, a type of message supported by the first UE for the receiving of the beam quality report of the second UE, or an identifier of a UE coordination procedure between the first UE and the second UE, the UE coordination procedure being employed in the detecting.
Example 10 may be combined with any of Examples 1-9 and further includes receiving, from the network entity and responsive to the sending of the indication, control signaling with information related to the UE group, wherein the information includes at least one of: a UE group flag indicating that the first UE is in the UE group, a flag indicating that the first UE provides the single beam report to the network entity, a measurement cycle characteristic, a beam report configuration for preparing the single beam report, or a frequency of the single beam report.
Example 11 may be combined with any of Examples 1-10 and further includes transmitting, to the network entity, the single beam report for the UEs in the UE group according to a measurement performed on a set of channel measurement resources, CMRs.
Example 12 is a method of wireless communication performed by a network entity, the method including: receiving, from a UE, an indication that the UE satisfies a grouping criterion for being in a UE group that provides a single beam report for UEs in the UE group to the network entity; and responsive to the receiving of the indication, transmitting control signaling that includes information to adjust the UE group.
Example 13 may be combined with Examples 12 and includes that the information indicates: adding the UE to the UE group if the indication corresponds to the grouping criterion being satisfied for the UE; or removing the UE from the UE group if the indication corresponds to the grouping criterion not being satisfied for the UE.
Example 14 may be combined with any of Examples 12-13 and further includes relaying, to the UE from a second UE, a beam quality report before the receiving of the indication.
Example 15 may be combined with any of Examples 12-14 and further includes transmitting, to the UE, a configuration indicating the grouping criterion.
Example 16 may be combined with any of Examples 12-15 and further includes receiving, from the UE, a UE capability report indicating a capability of the UE to operate within the UE group.
Example 17 is an apparatus for wireless communication for implementing a method as in any of examples 1-16.
Example 18 is an apparatus for wireless communication including means for implementing a method as in any of examples 1-16.
Example 19 is a non-transitory computer-readable medium storing computer executable code, the code when executed by a processor causes the processor to implement a method as in any of examples 1-16.

What is claimed is:

1. A method of wireless communication performed by a first user equipment (UE), the method comprising:
receiving a beam quality report of a second UE;
detecting whether a first beam quality based on beam measurements at the first UE and a second beam quality at the second UE, according to the beam quality report, satisfy a grouping criterion; and
based on the detecting, sending to a network entity, an indication that the first UE and the second UE belong to a UE group that provides a single beam report for UEs in the UE group to the network entity.

2. The method of claim 1, wherein the receiving the beam quality report of the second UE comprises:
obtaining, from the network entity, the beam quality report of the second UE.

3. The method of claim 1, wherein the receiving the beam quality report of the second UE comprises:
obtaining, from a sidelink communication with the second UE, the beam quality report of the second UE.

4. The method of claim 1, wherein the grouping criterion requires a difference between the first beam quality and the second beam quality to be within a predefined range, the first beam quality and the second beam quality being based on an amplitude or a signal-to-noise ratio for measurements performed on same signals by the first UE and the second UE.

5. The method of claim 1, further comprising:
receiving, from the network entity, a configuration indicating the grouping criterion.

6. The method of claim 5, wherein the configuration further indicates at least one of:
a radio network temporary identifier (RNTI) employed in the receiving of the beam quality report,
a configuration identifier for the single beam report,
a serving cell identifier for the single beam report, or
a bandwidth part (BWP) identifier associated with the single beam report.

7. The method of claim 1, wherein the sending of the indication occurs:
when the grouping criterion is satisfied while the first UE is not in the UE group, or
when the grouping criterion is not satisfied while the first UE is included in the group.

8. The method of claim 1, further comprising:
transmitting, to the network entity, a UE capability report indicating a capability of the first UE to operate within the UE group.

9. The method of claim 8, wherein the UE capability report indicates at least one of:
a maximum number of measured beams to report to the network entity,
a type of message supported by the first UE for the receiving of the beam quality report of the second UE, or
an identifier of a UE coordination procedure between the first UE and the second UE, the UE coordination procedure being employed in the detecting.

10. The method of claim 1, further comprising:
receiving, from the network entity and responsive to the sending of the indication, control signaling with information related to the UE group, wherein the information includes at least one of:
a UE group flag indicating that the first UE is in the UE group,
a flag indicating that the first UE provides the single beam report to the network entity,
a measurement cycle characteristic,
a beam report configuration for preparing the single beam report, or
a frequency of the single beam report.

11. The method of claim 1, further comprising:
transmitting, to the network entity, the single beam report for the UEs in the UE group according to a measurement performed on a set of channel measurement resources (CMRs).

12. A method of wireless communication performed by a network entity, the method comprising:
receiving, from a user equipment (UE), an indication that the UE satisfies a grouping criterion for being in a UE group that provides a single beam report for UEs in the UE group to the network entity; and
responsive to the receiving of the indication, transmitting control signaling that includes information to adjust the UE group.

13. The method of claim 12, wherein the information indicates:
adding the UE to the UE group if the indication corresponds to the grouping criterion being satisfied for the UE; or
removing the UE from the UE group if the indication corresponds to the grouping criterion not being satisfied for the UE.

14. The method of claim 12, further comprising:
relaying, to the UE from a second UE, a beam quality report before the receiving of the indication.

15. The method of claim 12, further comprising:
transmitting, to the UE, a configuration indicating the grouping criterion.

16. The method of claim 12, further comprising:
receiving, from the UE, a UE capability report indicating a capability of the UE to operate within the UE group.

17. An apparatus for wireless communication at a first user equipment (UE), comprising:
a transceiver;
a memory; and
a processor coupled to the memory and the transceiver, the processor configured to:
receive a beam quality report of a second UE;
detect whether a first beam quality based on beam measurements at the first UE and a second beam quality at the second UE, according to the beam quality report. satisfy a grouping criterion; and
based on the detecting, sending to a network entity, an indication that the first UE and the second UE belong to a UE group that provides a single beam report for UEs in the UE group to the network entity.

18. The apparatus of claim 17, wherein to receive the beam quality report of the second UE the processor configured to:
obtain, from the network entity, the beam quality report of the second UE.

19. The apparatus of claim 17, wherein to receive the beam quality report of the second UE the processor configured to:
obtain, from a sidelink communication with the second UE, the beam quality report of the second UE.

20. The apparatus of claim 17, wherein the grouping criterion requires a difference between the first beam quality and the second beam quality to be within a predefined range, the first beam quality and the second beam quality based on an amplitude or a signal-to-noise ratio for measurements preformed on same signals by the first UE and the second UE.
